(19) United States
(12) Patent Application Publication
(10) Pub. No.: US 2023/0305471 A1
(43) Pub. Date: Sep. 28, 2023

(54) PRINTING APPARATUS MANAGEMENT SYSTEM THAT CALCULATES AMOUNT OF CARBON DIOXIDE EMITTED BY PRINTING APPARATUS IN ITS LIFETIME AND METHOD FOR PRODUCING CARBON DIOXIDE EMISSION AMOUNT REPORT

(71) Applicant: SEIKO EPSON CORPORATION, Tokyo (JP)

(72) Inventors: Tomoyuki AMINO, Matsumoto (JP); Takahiro WAKASA, Shiojiri (JP); Yasuo NOMURA, Matsumoto (JP); Takashi FUKASE, Matsumoto (JP)

(21) Appl. No.: 18/186,981

(22) Filed: Mar. 21, 2023

(30) Foreign Application Priority Data
Mar. 23, 2022 (JP) 2022-046482

(51) Int. Cl. G03G 15/00

(52) U.S. Cl. CPC G03G 15/55; G03G 15/5016

(57) ABSTRACT

Provided is a printing apparatus management system that calculates an amount of carbon dioxide emitted by a printing apparatus in a lifetime of the printing apparatus.

The present application is based on, and claims priority from JP Application Serial Number 2022-046482, filed Mar. 23, 2022, the disclosure of which is hereby incorporated by reference herein in its entirety.

### BACKGROUND

### 1. Technical Field

The present disclosure relates to a printing apparatus management system and a method for producing a carbon dioxide emission amount report.

### 2. Related Art

From the perspective of environmental load reduction nowadays, printing apparatuses such as copiers, facsimile machines, and printers are also expected to be introduced to the market as merchandises aimed to reduce the load on the global environment. For example, JP-A-2013-031959 discloses an image formation apparatus that takes the amount of greenhouse effect gas emitted by its expendables into consideration from the perspective of reducing environmental load.

However, the technique described in JP-A-2013-031959 is not adequate to meet the recent increasing demands for reducing environmental load and has room for improvement.

### SUMMARY

An aspect of a printing apparatus management according to the present disclosure is a printing apparatus management system that calculates an amount of carbon dioxide emitted by a first printing apparatus in a lifetime of the first printing apparatus, including: a processor that calculates, based on first calculation information, the amount of carbon dioxide emitted by the first printing apparatus in the lifetime; and an output unit that outputs a calculation result obtained by the processor, in which the first calculation information includes a usage quantity of a first material forming the first printing apparatus, a first emission coefficient indicating a unit amount of carbon dioxide emissions associated with production of the first material, a second emission coefficient indicating a unit amount of carbon dioxide emissions associated with disposal of the first material, a weight of the first printing apparatus, a third emission coefficient indicating a unit amount of carbon dioxide emissions associated with production of the first printing apparatus, a first transportation distance of transportation of the first printing apparatus using first transportation unit, a fourth emission coefficient indicating a unit amount of carbon dioxide emissions associated with transportation using the first transportation unit, a type of an expendable used for the first printing apparatus, a quantity of the expendable used for the first printing apparatus, a usage quantity of a second material forming the expendable, a fifth emission coefficient indicating a unit amount of carbon dioxide emissions associated with production of the second material, a sixth emission coefficient indicating a unit amount of carbon dioxide emissions associated with disposal of the second material, a weight of the expendable, a seventh emission coefficient indicating a unit amount of carbon dioxide emissions associated with production of the expendable, a second transportation distance of transportation of the expendable using second transportation unit, an eighth emission coefficient indicating a unit amount of carbon dioxide emissions associated with transportation using the second transportation unit, an amount of electric power consumed by the first printing apparatus, and a ninth emission coefficient indicating a unit amount of carbon dioxide emissions per amount of electric power.

An aspect of a method for producing a carbon dioxide emission amount report according to the present disclosure is a method for producing a carbon dioxide emission amount report for reporting a lifetime emission amount of carbon dioxide emitted by a merchandise, the method including: a step of obtaining first calculation information used to calculate the lifetime emission amount of carbon dioxide; a step of calculating the lifetime emission amount based on the first calculation information obtained; and a step of producing a carbon dioxide emission amount report stating the lifetime emission amount calculated, in which the first calculation information includes a usage quantity of a first material forming the merchandise, a first emission coefficient indicating a unit amount of carbon dioxide emissions associated with production of the first material, a second emission coefficient indicating a unit amount of carbon dioxide emissions associated with disposal of the first material, a weight of the merchandise, a third emission coefficient indicating a unit amount of carbon dioxide emissions associated with production of the merchandise, a first transportation distance of transportation of the merchandise using first transportation unit, a fourth emission coefficient indicating a unit amount of carbon dioxide emissions associated with transportation using the first transportation unit, a type of an expendable used for the merchandise, a quantity of the expendable used for the merchandise, a usage quantity of a second material forming the expendable, a fifth emission coefficient indicating a unit amount of carbon dioxide emissions associated with production of the second material, a sixth emission coefficient indicating a unit amount of carbon dioxide emissions associated with disposal of the second material, a weight of the expendable, a seventh emission coefficient indicating a unit amount of carbon dioxide emissions associated with production of the expendable, a second transportation distance of transportation of the expendable using second transportation unit, an eighth emission coefficient indicating a unit amount of carbon dioxide emissions associated with transportation using the second transportation unit, an amount of electric power consumed by the merchandise, and a ninth emission coefficient indicating a unit amount of carbon dioxide emissions per amount of electric power.

### BRIEF DESCRIPTION OF THE DRAWINGS

FIG. 1 is a diagram showing the configuration of a printing apparatus management system.

FIG. 2 is a diagram showing an example of calculation information stored in a merchandise information data server.

FIG. 3 is a diagram showing an example of calculation information stored in a base location electric power information data server.

FIG. 4 is a diagram showing an example of calculation information stored in a transportation information data server.

FIG. 5 is a diagram showing an example of calculation information stored in an intensity information data server.

FIGS. 6A and 6B are diagrams showing an example of a method for calculating the amount of carbon dioxide emissions associated with manufacturing and disposal of a printing apparatus.

FIGS. 7A and 7B are diagrams showing an example of a method for calculating the amount of carbon dioxide emissions associated with manufacturing and disposal of an expendable used for the printing apparatus.

FIGS. 8A and 8B are diagrams showing an example method for calculating the amount of carbon dioxide emitted by the printing apparatus in its lifetime.

### DESCRIPTION OF EXEMPLARY EMBODIMENTS

A favorable embodiment of the present disclosure is described below using the drawings. The drawings used herein are for the convenience of description. Note that the embodiment described below is not intended to unreasonably limit the nature of the present disclosure described in the scope of claims. Also, not all the configurations described below are essential components of the present disclosure.

### 1. Overview of the Configuration and Operation of the Printing Apparatus Management System

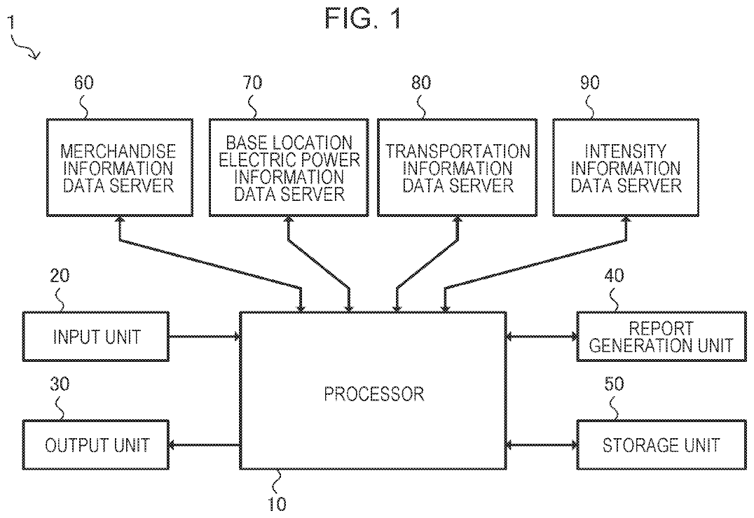

The configuration of a printing apparatus management system 1 of the present embodiment is described. FIG. 1 is a diagram showing the configuration of the printing apparatus management system 1. As shown in FIG. 1, the printing apparatus management system 1 includes a processor 10, an input unit 20, an output unit 30, a report generation unit 40, a storage unit 50, a merchandise information data server 60, a base location electric power information data server 70, a transportation information data server 80, and an intensity information data server 90. Then, the printing apparatus management system 1 calculates the amount of carbon dioxide that a printing apparatus emits in its lifetime.

The input unit 20 is an input interface for a user to input operation information to the printing apparatus management system 1, and has, for example, an operation panel having one or more operation switches. Note that there is no limitation as to the input unit 20 as long as operation information in accordance with a user's operation can be inputted to the processor 10 to be described later, and for example, a host computer may be provided in place of or in addition to the operation panel described above so that the printing apparatus management system 1 can be operated by the host computer.

The processor 10 calculates the amount of carbon dioxide emitted by a printing apparatus in its lifetime in accordance with operation information inputted from the input unit 20.

Specifically, when model information identifying a printing apparatus for which to calculate a carbon dioxide emission amount is inputted to the printing apparatus management system 1 by a user's operation of the input unit 20, the processor 10 obtains, from the merchandise information data server 60, the base location electric power information data server 70, the transportation information data server 80, and the intensity information data server 90, calculation information for calculating the amount of carbon dioxide emitted by the printing apparatus corresponding to the model information inputted. In other words, the processor 10 obtains calculation information used to calculate the amount of carbon dioxide emitted by the target printing apparatus.

Based on the calculation information obtained, the processor 10 calculates the amount of carbon dioxide emitted by the printing apparatus. Specifically, based on the calculation information obtained, the processor 10 calculates the amount of carbon dioxide emitted by a printing apparatus in its lifetime, such as the amount of carbon dioxide emissions associated with the manufacturing and disposal of the printing apparatus and the amount of carbon dioxide emissions associated with the usage of the printing apparatus, separately according to the state, status, configuration, or the like of the printing apparatus.

The processor 10 then causes the storage unit 50 to retain information on the calculated carbon dioxide emission amount. There is no limitation as to the storage unit 50 as long as the storage unit 50 can retain the information on the carbon dioxide emission amount calculated by the processor 10 for at least a certain period of time, and a primary storage device, such as a register or cache memory, or a secondary storage device, such as a hard disk, can be used.

In response to a user's request, the processor 10 calculates the amount of carbon dioxide emitted by a printing apparatus by adding the carbon dioxide emission amounts separately calculated. Specifically, when a user operates the input unit 20 and requests output of the amount of carbon dioxide emitted by a printing apparatus in its lifetime, the processor 10 extracts, from the carbon dioxide emission amount information stored in the storage unit 50, pieces of information necessary to calculate the amount of carbon dioxide emitted by the printing apparatus in its lifetime, and then combines the extracted pieces of information. The processor 10 thus calculates the amount of carbon dioxide emitted by the printing apparatus in its lifetime. The processor 10 then outputs the calculated lifetime carbon dioxide emission amount to the report generation unit 40.

Based on the calculation results on the carbon dioxide emission amount inputted from the processor 10, the report generation unit 40 generates a carbon dioxide emission amount report stating the amount of carbon dioxide emitted by the printing apparatus. Then, the processor 10 outputs, from the output unit 30, the carbon dioxide emission amount report generated by the report generation unit 40. In this way, a user is provided with the carbon dioxide emission amount report stating the amount of carbon dioxide emitted by the printing apparatus. In other words, the printing apparatus management system 1 produces a carbon dioxide emission amount report stating the carbon dioxide emission amount calculated by the processor 10.

In addition to notifying the user of the above-described carbon dioxide emission amount report, the output unit 30 notifies the user when there is any insufficiency in the calculation information obtained from the merchandise information data server 60, the base location electric power information data server 70, the transportation information data server 80, and the intensity information data server 90. As such an output unit 30, a display panel capable of displaying information such as a carbon dioxide emission amount report or a printer capable of printing information such as a carbon dioxide emission amount report may be used.

In the printing apparatus management system 1, the processor 10 may provide a user with the calculated carbon dioxide emission amount via the output unit 30 without outputting the calculated carbon dioxide emission amount to the report generation unit 40. In this case, the carbon dioxide emission amount report may be produced by the user based on the carbon dioxide emission amount provided thereto. To be more specific, a configuration for producing a carbon dioxide emission amount report stating the carbon dioxide emission amount calculated using the printing apparatus management system 1 is not limited to the processor 10 and the report generation unit 40.

As thus described, in the printing apparatus management system 1 of the present embodiment, in response to a user's request, the processor 10 calculates the amount of carbon dioxide emitted by a printing apparatus based on calculation information stored in the merchandise information data server 60, the base location electric power information data server 70, the transportation information data server 80, and the intensity information data server 90, and the output unit 30 outputs the calculation result on the amount of carbon dioxide emitted by the printing apparatus.

Thus, when a user requests calculation of the amount of carbon dioxide emitted by a printing apparatus in its lifetime, in the printing apparatus management system 1 of the present embodiment, in response to the user's request, the processor 10 calculates the amount of carbon dioxide emitted by the printing apparatus in its lifetime based on calculation information stored in the merchandise information data server 60, the base location electric power information data server 70, the transportation information data server 80, and the intensity information data server 90, and the output unit 30 outputs the calculation result obtained by the processor 10 on the amount of carbon dioxide emitted by the printing apparatus in its lifetime.

Also, a carbon dioxide emission amount report producing method for producing a carbon dioxide emission amount report for reporting a carbon dioxide emission amount using the printing apparatus management system 1 of the present embodiment includes, in response to a user's request, a step of obtaining, by the processor 10, calculation information used to calculate a carbon dioxide emission amount from the merchandise information data server 60, the base location electric power information data server 70, the transportation information data server 80, and the intensity information data server 90, a step of calculating, by the processor 10, the carbon dioxide emission amount based on the calculation information obtained, and a step of producing, by the user or the report generation unit 40, a carbon dioxide emission amount report stating the emission amount calculated by the processor 10.

Similarly, a carbon dioxide emission amount report producing method for producing a carbon dioxide emission amount report reporting a lifetime carbon dioxide emission amount using the printing apparatus management system 1 of the present embodiment when a user requests calculation of the amount of carbon dioxide emitted by a printing apparatus in its lifetime includes a step of obtaining, by the processor 10, calculation information used to calculate a lifetime carbon dioxide emission amount from the merchandise information data server 60, the base location electric power information data server 70, the transportation information data server 80, and the intensity information data server 90, a step of calculating, by the processor 10, the lifetime carbon dioxide emission amount based on the calculation information obtained, and a step of producing, by the user or the report generation unit 40, a carbon dioxide emission amount report stating the lifetime emission amount calculated by the processor 10.

### 2. Configurations of the Data Servers

A description is given of a specific example of calculation information used by the processor 10 to calculate a carbon dioxide emission amount in the printing apparatus management system 1 configured as described above. As described earlier, calculation information used to calculate a carbon dioxide emission amount in the printing apparatus management system 1 of the present embodiment is separately stored in the following four data servers in the printing apparatus management system 1: the merchandise information data server 60, the base location electric power information data server 70, the transportation information data server 80, and the intensity information data server 90. Now, examples of the data structures of pieces of information stored in the merchandise information data server 60, the base location electric power information data server 70, the transportation information data server 80, and the intensity information data server 90 are described.

Although the following description assumes that the printing apparatus management system 1 of the present embodiment includes four data servers, namely the merchandise information data server 60, the base location electric power information data server 70, the transportation information data server 80, and the intensity information data server 90, the number of data servers that the printing apparatus management system 1 includes is not limited to four. Thus, in the printing apparatus management system 1 of the present embodiment, the locations where pieces of calculation information used to calculate a carbon dioxide emission amount are stored are not limited to the four data servers, which are the merchandise information data server 60, the base location electric power information data server 70, the transportation information data server 80, and the intensity information data server 90, and may be any storage circuits such as data servers provided in a manner to be communicative with the processor 10.

Also, the following description may refer to a printing apparatus for which the printing apparatus management system 1 calculates a carbon dioxide emission amount and an expendable used for the printing apparatus as merchandises collectively.

### 2.1 Merchandise Information Data Server

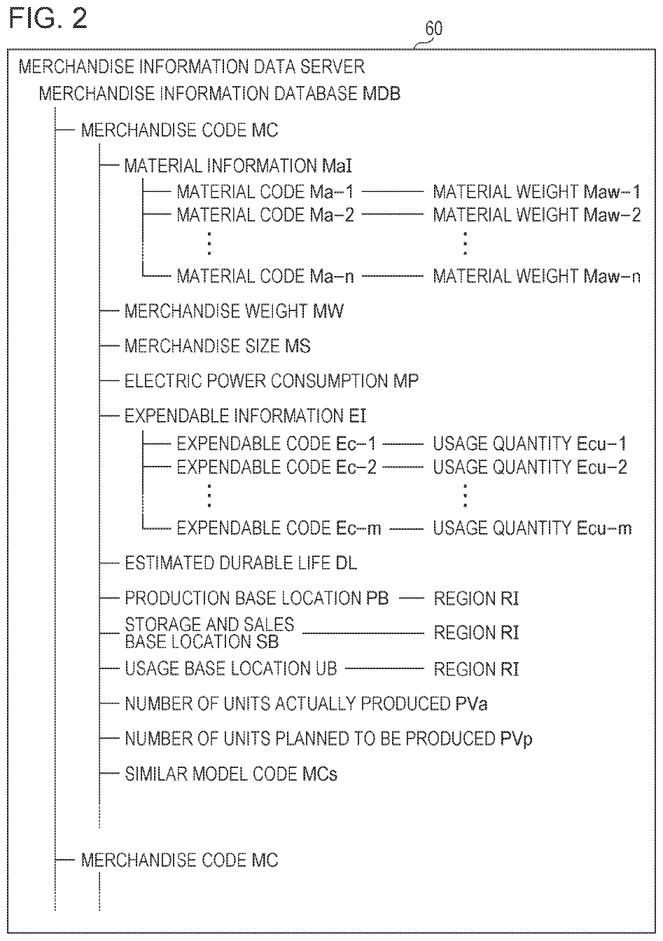

First, an example of calculation information stored in the merchandise information data server 60 is described. FIG. 2 is a diagram showing an example of calculation information stored in the merchandise information data server 60. The merchandise information data server 60 stores various kinds of information related to merchandises including a printing apparatus and an expendable used for the printing apparatus.

As shown in FIG. 2, a merchandise information database MDB is built in the merchandise information data server 60. Also, a plurality of merchandise codes MC are stored in the merchandise information database MDB.

The merchandise code MC is a predetermined code for identifying a merchandise and has a one-to-one correspondence with the merchandise identified thereby. Specifically, when information on v printing apparatuses and information on w expendables are stored in the merchandise information database MDB, v merchandise codes MC corresponding to the respective v printing apparatuses and w merchandise codes MC corresponding to the respective w expendables are stored in the merchandise information database MDB. There is no limitation as to the merchandise code MC as long as it can identify a merchandise in a one-to-one manner. A dedicated code may be used, or a merchandise model number, a development code, or the like may be used.

Also, the following pieces of merchandise-related information are stored in the merchandise information database MDB while being connected to a corresponding merchandise code MC: material information MaI, merchandise weight MW, merchandise size MS, electric power consumption MP, expendable information EI, estimated durable life DL, production base location PB, storage and sales base location SB, number of units actually produced PVa, number of units planned to be produced PVp, and similar model code MCs. In other words, various pieces of information corresponding to a merchandise identified by a merchandise code MC are stored in the merchandise information database MDB, the various pieces of information including the material information MaI, the merchandise weight MW, the merchandise size MS, the electric power consumption MP, the expendable information EI, the estimated durable life DL, the production base location PB, the storage and sales base location SB, the number of units actually produced PVa, the number of units planned to be produced PVp, and the similar model code MCs.

The material information MaI includes information related to a material included in the merchandise identified by the merchandise code MC. Specifically, when the merchandise identified by the merchandise code MC is formed including n kinds of materials, the material information MaI includes material codes Ma-1 to Ma-n corresponding to the respective n kinds of materials and material weights Maw-1 to Maw-n indicating the amounts by which the respective n kinds of materials are contained in the merchandise. The material weights Maw-1 to Maw-n and the material codes Ma-1 to Ma-n are stored in the merchandise information database MDB while being connected to each other, respectively. In the following description, the material codes Ma-1 to Ma-n corresponding to the respective n kinds of materials included in the material information MaI may be referred to simply as a material code Ma unless discrimination is necessary and then described as having a material weight Maw connected thereto.

The merchandise weight MW includes information indicating the weight of the merchandise identified by the merchandise code MC, and the merchandise size MS includes information on the size of the merchandise identified by the merchandise code MC, such as, for example, the length, width, and depth of the merchandise. In other words, information indicating the structure of the merchandise identified by the merchandise code MC is stored in the merchandise information database MDB.

The electric power consumption MP includes information related to the amount of electric power consumed by the merchandise identified by the merchandise code MC. Specifically, the electric power consumption MP is information related to the amount of electric power consumed by the merchandise identified by the merchandise code MC, and when, for example, the merchandise identified by the merchandise code MC is a printing apparatus, the electric power consumption MP may be information on the amount of electric power that the printing apparatus consumes when printing a pattern defined by International Standard ISO/IEC24712 or may be information on the amount of electric power that the printing apparatus consumes when not printing. Also, when, for example, the merchandise identified by the merchandise code MC is a printing apparatus, the electric power consumption MP may be an integral amount of electric power that the printing apparatus consumes by repetitively executing a predetermined operation state, and may be, for example, a typical electricity consumption (TEC) value of the printing apparatus.

The expendable information EI includes information related to an expendable used for the merchandise identified by the merchandise code MC. Specifically, when the merchandise identified by the merchandise code MC uses m kinds of expendables, the expendable information EI includes expendable codes Ec-1 to Ec-m corresponding to the respective m kinds of expendables. The expendable codes Ec-1 to Ec-m are codes for identifying expendables as merchandises and may be merchandise codes MC for identifying the expendables. In other words, the expendable codes Ec-1 to Ec-m corresponding to the respective m kinds of expendables refer to the merchandise codes MC for identifying the expendables. When the merchandise identified by the merchandise code MC is a printing apparatus, the expendable codes Ec-1 to Ec-m include, as expendables used for the printing apparatus, not only a merchandise expended when the printing apparatus is used, such as the type of compatible ink or usable recording paper or a maintenance box, but also a merchandise replaced when the printing apparatus malfunctions or deteriorates, such as, for example, a compatible print head.

Also, the expendable information EI includes expendable usage quantities Ecu-1 to Ecu-m indicating, when m kinds of expendables are used for the merchandise identified by the merchandise code MC, the usage quantities of those expendables. Specifically, the expendable information EI includes the expendable usage quantities Ecu-1 to Ecu-m connected respectively to the expendable codes Ec-1 to Ec-m. The expendable usage quantities Ecu-1 to Ecu-m are each information indicating the number of times an expendable identified by one of the expendable codes Ec-1 to Ec-m can be used when the expendable is used for the merchandise identified by the merchandise code MC. For example, when the expendables identified by the expendable codes Ec-1 to Ec-m are ink cartridges, the expendable usage quantities Ecu-1 to Ecu-m include information such as the number of sheets of media printable when the ink cartridges are used for the printing apparatus identified by the merchandise code MC.

In the following description, the expendable codes Ec-1 to Ec-m corresponding to the respective m kinds of expendables included in the expendable information EI may be referred to simply as an expendable code Ec unless discrimination is necessary, and then the expendable code Ec may be described as having an expendable usage quantity Ecu connected thereto.

The estimated durable life DL is information on the estimated life of the merchandise identified by the merchandise code MC and includes, for example, information based on a design expected life calculated when the merchandise was designed or the like. For example, when the merchandise identified by the merchandise code MC is a printing apparatus, the estimated durable life DL includes, e.g., design information on a period of time in which the printing apparatus can normally operate and the number of sheets of media for which the printing apparatus can execute printing processing normally. Note that the estimated durable life DL may include various kinds of information for estimating the life of a merchandise in addition to the above pieces of information.

The production base location PB includes information on a production base location, such as a factory, where the merchandise identified by the merchandise code MC is produced, and the storage and sales base location SB includes information on a warehouse where the merchandise identified by the merchandise code MC is stored, and a sales company, a retailer, or the like that transfers the merchandise identified by the merchandise code MC to a user. Also, a usage base location UB includes information on a location of usage where the merchandise identified by the merchandise code MC is used. Regions RI are connected to the production base location PB, the storage and sales base location SB, and the usage base location UB, to identify the specific locations of the production base location PB, the storage and sales base location SB, and the usage base location UB. The region RI is information on a specific location where the production base location PB, the storage and sales base location SB, or the usage base location UB is located. For example, the region RI may be information on the name, administrative division, or the like of a country or region where the production base location PB, the storage and sales base location SB, or the usage base location UB is located, or may be information on an address with which the location of the production base location PB, the storage and sales base location SB, or the usage base location UB is identifiable.

The number of units actually produced PVa includes information on the actual number of units of the merchandise identified by the merchandise code MC that are actually produced, and the number of units planned to be produced PVp includes information on the number of units of the merchandise identified by the merchandise code MC that are expected to be produced in the future. Note that it may be configured such that the number of units actually produced PVa and the number of units planned to be produced PVp refer to a database holding the location in which or to which the merchandise identified by the merchandise code MC is manufactured or sold.

The similar model code MCs is information for identifying a merchandise similar to the merchandise identified by the merchandise code MC, and may be the merchandise code MC of a model similar to the merchandise identified by the merchandise code MC. Examples of a similar merchandise identified by the similar model code MCs include an earlier model of the merchandise identified by the merchandise code MC. When the processor 10 calculating the amount of carbon dioxide emitted by the merchandise identified by the merchandise code MC finds that there is insufficiency in some of the pieces of the information stored in the merchandise information data server 60, the base location electric power information data server 70, the transportation information data server 80, and the intensity information data server 90, the similar model code MCs is used to obtain complementary information for compensating for the insufficiency.

Specifically, calculation information corresponding to the merchandise identified by the merchandise code MC includes the similar model code MCs indicating a merchandise related to the merchandise identified by the merchandise code MC, and when there is insufficiency in the calculation information corresponding to the merchandise identified by the merchandise code MC, the processor 10 compensates for the insufficiency by using the calculation information corresponding to the merchandise identified by the similar model code MCs and calculates the amount of carbon dioxide that the merchandise identified by the merchandise code MC emits in its lifetime.

### 2.2 Base Location Electric Power Information Data Server

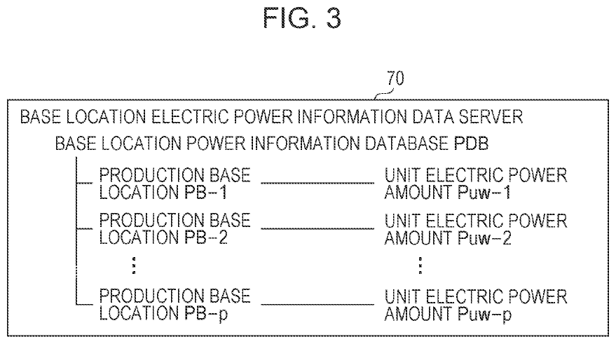

Next, an example of calculation information stored in the base location electric power information data server 70 is described. FIG. 3 is a diagram showing an example of calculation information stored in the base location electric power information data server 70. In the base location electric power information data server 70, unit electric power amounts in the respective p production base locations PC where merchandises are produced are recorded. Note that in the following description, the p production base locations PB may be referred to as production base locations PB-1 to PB-p.

As shown in FIG. 3, a base location electric power information database PDB is built in the base location electric power information data server 70. In the base location electric power information database PDB, the production base locations PB-1 to PB-p and unit electric power amounts Puw-1 to Puw-p connected respectively to the production base locations PB-1 to PB-p are stored. Specifically, in the base location electric power information database PDB, the unit electric power amount Puw-1 of the production base location PB-1 is stored in connection with the production base location PB-1, and the unit electric power amount Puw-p of the production base location PB-p is stored in connection with the production base location PB-p. Note that in the following description, the production base location PB may be described as being stored in connection with the unit electric power amount Puw.

Here, the unit electric power amount Puw-1 stored in the base location electric power information database PDB is a value obtained by dividing the total amount of electric power used at the production base location PB-1 in a predetermined period of time by the total weight of the merchandise produced at the production base location PB-1 in the predetermined period of time, and is, in other words, equivalent to the amount electric power per unit weight of the merchandise required to produce the merchandise at the production base location PB-1. Similarly, the unit electric power amount Puw-p stored in the base location electric power information database PDB is a value obtained by dividing the total amount of electric power used at the production base location PB-p in a predetermined period of time by the total weight of the merchandise produced at the production base location PB-p in the predetermined period of time, and is, in other words, equivalent to the amount of electric power per unit weight of the merchandise required to produce the merchandise at the production base location PB-p.

### 2.3 Transportation Information Data Server

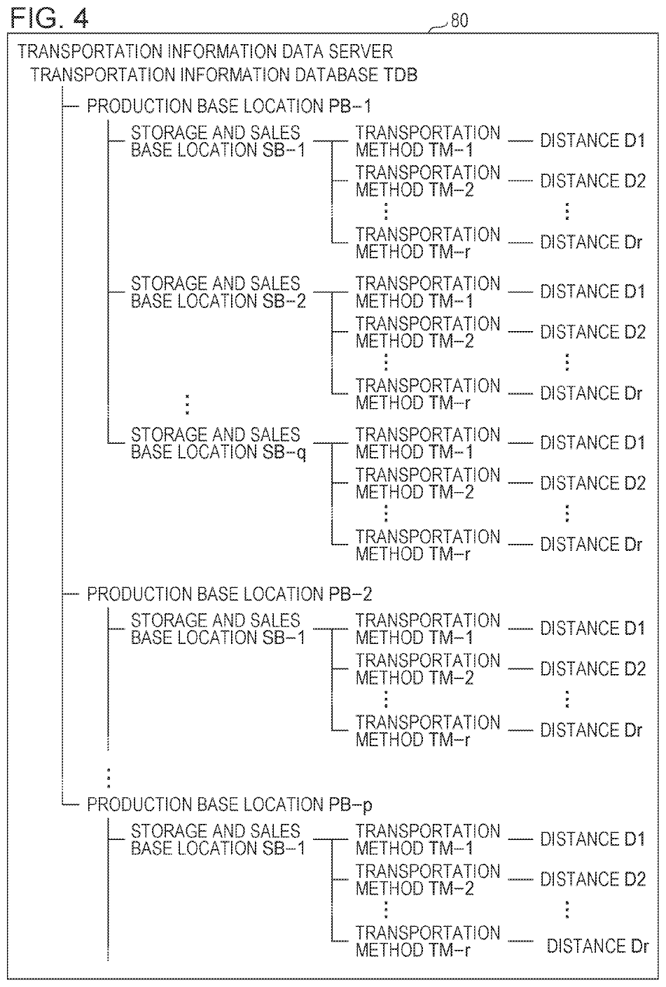

Next, an example of calculation information stored in the transportation information data server 80 is described. FIG. 4 is a diagram showing an example of calculation information stored in the transportation information data server 80. In the transportation information data server 80, a method and distance of transportation for transporting a merchandise from each of the p production base locations PB to any of the q storage and sales base locations SB are recorded. Note that in the following description, the q storage and sales base locations SB may be referred to as storage and sales base locations SB-1 to SB-q.

Specifically, as shown in FIG. 4, a transportation information database TDB is built in the transportation information data server 80. In the transportation information database TDB, the production base location PB-1 is stored in connection with the storage and sales base locations SB-1 to SB-q. Then, the storage and sales base location SB-1 connected to the production base location PB-1 has transportation methods TM-1 to TM-r connected thereto, and the transportation methods TM-1 to TM-r have corresponding distances D1 to Dr connected thereto, respectively. Similarly, the storage and sales base location SB-q connected to the production base location PB-1 has transportation methods TM-1 to TM-r connected thereto, and the transportation methods TM-1 to TM-r have corresponding distances D1 to Dr connected thereto, respectively. Thus, relations between methods of transportation used in transporting a merchandise from the production base location PB-1 to the storage and sales base locations SB-1 to SB-q and distances for the transportation methods are stored in the transportation information database TDB.

Specifically, stored in the transportation information database TDB is transportation information indicating that, in a case of transporting the merchandise from the production base location PB-1 to the storage and sales base location SB-1, the merchandise is transported for the distance D1 when the transportation method TM-1 is used and the merchandise is transported for the distance Dr when the transportation method TM-r is used.

Also, in the transportation information database TDB, the production base location PB-p is stored in connection with the storage and sales base locations SB-1 to SB-q. Then, the storage and sales base location SB-1 connected to the production base location PB-p has transportation methods TM-1 to TM-r connected thereto, and the transportation methods TM-1 to TM-r have corresponding distances D1 to Dr connected thereto, respectively. Similarly, the storage and sales base location SB-q connected to the production base location PB-p has transportation methods TM-1 to TM-r connected thereto, and the transportation methods TM-1 to TM-r have corresponding distances D1 to Dr connected thereto, respectively.

In this way, relations between the transportation methods TM-1 to TM-r used in transporting the merchandise from any of the production base locations PB-1 to PB-p to the storage and sales base locations SB-1 to SB-q and the distances D1 to Dr corresponding to the transportation methods TM-1 to TM-r are stored in the transportation information database TDB. For example, the transportation methods TM-1 to TM-r may be classified as a truck, a ship, an airplane, and the like, and more detailed classifications may be made based on their emissions or the like in addition to the classification of truck, ship, airplane, and the like.

In the following description, the transportation methods TM-1 to TM-r may be referred to simply as a transportation method TM unless discrimination is necessary, and in that case, the transportation method TM may be described as having a distance D connected thereto.

### 2.4 Intensity Information Data Server

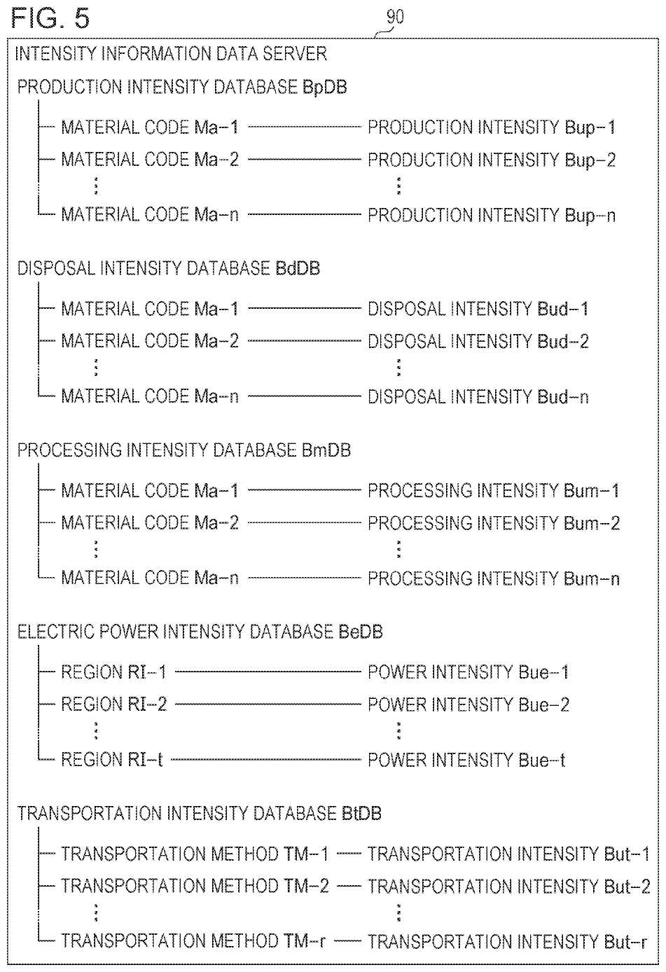

Next, an example of calculation information stored in the intensity information data server 90 is described. FIG. 5 is a diagram showing an example of calculation information stored in the intensity information data server 90. In the intensity information data server 90, predetermined coefficients for calculating the amount of carbon dioxide emitted by a merchandise in its lifetime are stored, the merchandise including a printing apparatus and an expendable used for the printing apparatus.

As shown in FIG. 5, a production intensity database BpDB, a disposal intensity database BdDB, a processing intensity database BmDB, an electric power intensity database BeDB, and a transportation intensity database BtDB are built in the intensity information data server 90.

Stored in the production intensity database BpDB are production intensities Bup-1 to Bup-n connected respectively to the material codes Ma-1 to Ma-n. The production intensity Bup-1 connected to the material code Ma-1 is a coefficient for defining the amount of carbon dioxide emitted per unit amount of the material corresponding to the material code Ma-1 when the material is produced, and the production intensity Bup-n connected to the material code Ma-n is a coefficient for defining the amount of carbon dioxide emitted per unit amount of the material corresponding to the material code Ma-n when the material is produced. A coefficient defining the amount of carbon dioxide emitted per unit amount of the material corresponding to the material code Ma when the material is produced may be referred to as a production intensity Bup herein.

Stored in the disposal intensity database BdDB are disposal intensities Bud-1 to Bud-n connected respectively to the material codes Ma-1 to Ma-n. The disposal intensity Bud-1 connected to the material code Ma-1 is a coefficient defining the amount of carbon dioxide emitted per unit of a material corresponding to the material code Ma-1 when the material is disposed of, and the disposal intensity Bud-n connected to the material code Ma-n is a coefficient defining the amount of carbon dioxide emitted per unit of a material corresponding to the material code Ma-n when the material is disposed of. A coefficient defining the amount of carbon dioxide emitted per unit amount of the material corresponding to the material code Ma when the material is disposed of may be referred to as a disposal intensity Bud herein.

Stored in the processing intensity database BmDB are processing intensities Bum-1 to Bum-n connected respectively to the material codes Ma-1 to Ma-n. The processing intensity Bum-1 connected to the material code Ma-1 is a coefficient for defining the amount of carbon dioxide emitted per unit amount of the material corresponding to the material code Ma-1 when the material is processed, and the processing intensity Bum-n connected to the material code Ma-n is a coefficient for defining the amount of carbon dioxide emitted per unit amount of the material corresponding to the material code Ma-n when the material is processed.

The processing intensities Bum-1 to Bum-n may be coefficients indicating unit carbon dioxide emission amounts defined based on a processing method used for the materials corresponding to the respective material codes Ma-1 to Ma-n. Also, a coefficient defining the amount of carbon dioxide emitted per unit amount of the material corresponding to the material code Ma when the material is processed may be referred to as a processing intensity Bum herein.

Stored in the electric power intensity database BeDB are electric power intensities Bue-1 to Bue-t connected to the respective t regions RI, namely the region RI-1 to the region RI-t. The electric power intensity Bue-1 connected to the region RI-1 is a coefficient contributed to by, e.g., the power generation method for generating electric power used at the region RI-1 and defining the amount of carbon dioxide emitted per unit amount of electric power used at the region RI-1, and the electric power intensity Bue-t connected to the region RI-t is a coefficient contributed to by, e.g., the power generation method for generating electric power used at the region RI-t and defining the amount of carbon dioxide emitted per unit amount of electric power used at the region RI-t. The amount of carbon dioxide emitted per unit amount of electric power used at the region RI may be referred to as electric power intensity Bue.

Stored in the transportation intensity database BtDB are transportation intensities But-1 to But-r connected respectively to the transportation methods TM-1 to TM-r. The transportation intensity But-1 connected to the transportation method TM-1 is a coefficient defining the amount of carbon dioxide emitted per unit weight of a merchandise by the transportation method TM-1 when the merchandise is transported using the transportation method TM-1, and the transportation intensity But-r connected to the transportation method TM-r is a coefficient defining the amount of carbon dioxide emitted per unit weight of a merchandise by the transportation method TM-r when the merchandise is transported using the transportation method TM-r. A coefficient defining the amount of carbon dioxide emitted per unit weight of a merchandise when the merchandise is transported using the transportation method TM may be referred to as a transportation intensity But.

The above-described coefficients recorded in the intensity information data server 90 to calculate carbon dioxide emission amounts may be coefficients defined by, for example, an official organization affiliated to the national or local government or may be coefficients calculated based on, e.g., the past performance or experience of a user of the printing apparatus management system 1.

### 3. Calculation of a Carbon Dioxide Emission Amount by the Processor

Next, a description is given of a method, executed by the processor 10, for calculating the amount of carbon dioxide emitted by a merchandise. As described earlier, in response to a user's request inputted via the input unit 20, the processor 10 obtains calculation information stored in the merchandise information data server 60, the base location electric power information data server 70, the transportation information data server 80, and the intensity information data server 90. Then, based on the calculation information obtained, the processor 10 calculates the amount of carbon dioxide emitted by a printing apparatus. To this end, the processor 10 calculates, based on the calculation information obtained, the amount of carbon dioxide emitted by the printing apparatus in its lifetime, such as the amount of carbon dioxide emissions associated with manufacturing and disposal of the printing apparatus and the amount of carbon dioxide emissions associated with usage of the printing apparatus, separately according to the state, operation status, configuration, and the like of the printing apparatus, and combines the calculated carbon dioxide emission amounts according to the user's request, thereby providing the user with information including the amount of carbon dioxide emitted by the printing apparatus in its lifetime.

3.1 Amounts of Carbon Dioxide Emissions Associated with Manufacturing and Disposal of the Printing Apparatus

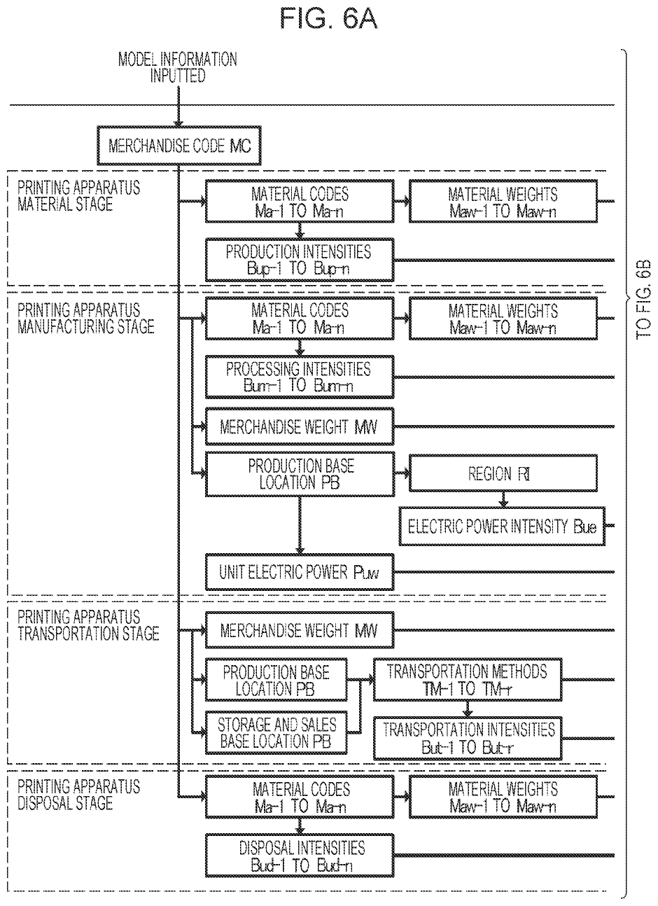

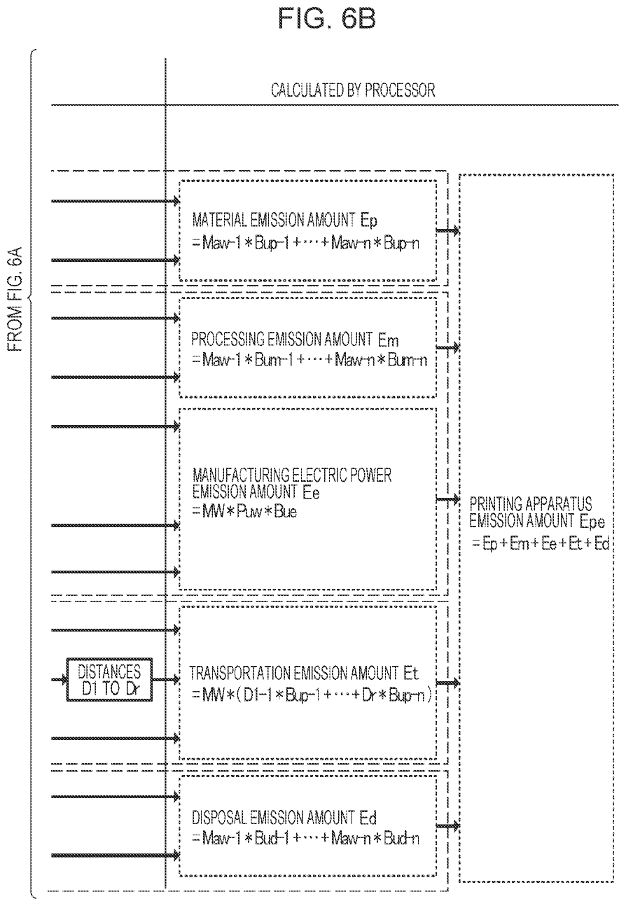

First, a description is given of an example of a method, executed by the processor 10, for calculating the amount of carbon dioxide emissions associated with manufacturing and disposal of a printing apparatus. FIGS. 6A and 6B are diagrams showing an example of a method for calculating the amount of carbon dioxide emissions associated with manufacturing and disposal of a printing apparatus. As shown in FIGS. 6A and 6B, to calculate the amount of carbon dioxide emissions associated with manufacturing and disposal of a printing apparatus, the processor 10 calculates the amounts of carbon dioxide emitted in the respective following four stages: a printing apparatus material stage, a printing apparatus manufacturing stage, a printing apparatus transportation stage, and a printing apparatus disposal stage.

First, calculation of the amount of carbon dioxide emitted in the printing apparatus material stage is described. The processor 10 calculates the amount of carbon dioxide emissions associated with production of a material included in the printing apparatus in the printing apparatus material stage.

When a merchandise code MC identifying a printing apparatus for which to calculate a carbon dioxide emission amount is inputted to the processor 10 by a user operating the input unit 20, the processor 10 obtains, from the merchandise information database MDB in the merchandise information data server 60, the material codes Ma-1 to Ma-n stored in the material information MaI on the printing apparatus corresponding to the merchandise code MC and the material weights Maw-1 to Maw-n corresponding respectively to the material codes Ma-1 to Ma-n. The processor 10 also obtains, from the production intensity database BpDB in the intensity information data server 90, the production intensities Bup-1 to Bup-n corresponding respectively to the material codes Ma-1 to Ma-n obtained from the merchandise information database MDB in the merchandise information data server 60.

After that, out of the material weights Maw-1 to Maw-n obtained, the processor 10 calculates a product of the material weight Maw-1 corresponding to the material code Ma-1 and the production intensity Bup-1 corresponding to the material code Ma-1. The processor 10 thus calculates the amount of carbon dioxide emitted when the material corresponding to the material code Ma-1 is produced.

Similarly, the processor 10 calculates products of the material weights Maw-2 to Maw-n corresponding to the material codes Ma-2 to Ma-n and the production intensities Bup-2 to Bup-n corresponding to the material codes Ma-2 to Ma-n, respectively. The processor 10 thus calculates the amounts of carbon dioxide emitted when the materials corresponding respectively to the material codes Ma-2 to Ma-n are produced.

Then, as a material emission amount Ep, the processor 10 calculates the sum of the calculated amounts of carbon dioxide emitted when the materials corresponding to the respective material codes Ma-1 to Ma-n are produced. This material emission amount Ep is equivalent to the amount of carbon dioxide emissions associated with production of the materials included in the printing apparatus. The processor 10 then stores the calculated material emission amount Ep in the storage unit 50.

Next, calculation of the amount of carbon dioxide emitted in the printing apparatus manufacturing stage is described. The processor 10 calculates the amount of carbon dioxide emissions associated with manufacturing of the printing apparatus in the printing apparatus manufacturing stage. To this end, as the amount of carbon dioxide emissions associated with manufacturing of the printing apparatus, the processor 10 calculates the amounts of carbon dioxide emissions associated with processing of the materials corresponding to the respective material codes Ma-1 to Ma-n included in the printing apparatus and the amount of carbon dioxide emitted in accordance with the amount of electric power used to manufacture the printing apparatus.

First, a description is given of calculation of the amounts of carbon dioxide emissions associated with processing of the materials corresponding to the respective material codes Ma-1 to Ma-n included in the printing apparatus. When a merchandise code MC identifying a printing apparatus for which to calculate a carbon dioxide emission amount is inputted to the processor 10 by a user operating the input unit 20, the processor 10 obtains, from the merchandise information database MDB in the merchandise information data server 60, material codes Ma-1 to Ma-n stored in the material information MaI on the printing apparatus corresponding to the merchandise code MC and the material weights Maw-1 to Maw-n corresponding respectively to the material codes Ma-1 to Ma-n. The processor 10 also obtains, from the processing intensity database BmDB in the intensity information data server 90, the processing intensities Bum-1 to Bum-n corresponding respectively to the material codes Ma-1 to Ma-n obtained from the merchandise information database MDB in the merchandise information data server 60.

After that, out of the material weights Maw-1 to Maw-n obtained, the processor 10 calculates a product of the material weight Maw-1 corresponding to the material code Ma-1 and the processing intensity Bum-1 corresponding to the material code Ma-1. The processor 10 thus calculates the amount of carbon dioxide emitted when the material corresponding to the material code Ma-1 is processed. Similarly, the processor 10 calculates products of the material weights Maw-2 to Maw-n corresponding to the material codes Ma-2 to Ma-n and the processing intensities Bum-2 to Bum-n corresponding to material codes Ma-2 to Ma-n, respectively. The processor 10 thus calculates the amounts of carbon dioxide emitted when the materials corresponding to the respective material codes Ma-2 to Ma-n are processed.

Then, as a processing emission amount Em, the processor 10 calculates the sum of the calculated amounts of carbon dioxide emitted when the materials corresponding to the respective material codes Ma-1 to Ma-n are processed. This processing emission amount Em is equivalent to the amount of carbon dioxide emissions associated with processing of the materials included in the printing apparatus. The processor 10 then stores the calculated processing emission amount Em in the storage unit 50.

Next, calculation of the amount of carbon dioxide emitted in accordance with the amount of electric power used to manufacture the printing apparatus is described. When a merchandise code MC identifying a printing apparatus for which to calculate a carbon dioxide emission amount is inputted to the processor 10 by a user operating the input unit 20, the processor 10 obtains, from the merchandise information database MDB in the merchandise information data server 60, the merchandise weight MW and the production base location PB of the printing apparatus corresponding to the merchandise code MC. The processor 10 also obtains, from the base location electric power information database PDB in the base location electric power information data server 70, the unit electric power amount Puw corresponding to the production base location PB obtained from the merchandise information database MDB in the merchandise information data server 60. The processor 10 also obtains, from the electric power intensity database BeDB in the intensity information data server 90, the electric power intensity Bue corresponding to the region RI connected to the production base location PB obtained from the merchandise information database MDB in the merchandise information data server 60.

Then, as a manufacturing electric power emission amount Ee, the processor 10 calculates a product of the merchandise weight MW, the unit electric power amount Puw, and the electric power intensity Bue obtained. This manufacturing electric power emission amount Ee is equivalent to the amount of carbon dioxide emitted in accordance with the amount of electric power used to manufacture the printing apparatus. The processor 10 then stores the calculated manufacturing electric power emission amount Ee in the storage unit 50.

Next, calculation of the amount of carbon dioxide emitted in the printing apparatus transportation stage is described. The processor 10 calculates the amount of carbon dioxide emissions associated with transportation of a printing apparatus in the printing apparatus transportation stage.

When a merchandise code MC identifying a printing apparatus for which to calculate a carbon dioxide emission amount is inputted to the processor 10 by a user operating the input unit 20, the processor 10 obtains, from the merchandise information database MDB in the merchandise information data server 60, the merchandise weight MW, the production base location PB, and the storage and sales base location SB of the printing apparatus corresponding to the merchandise code MC. The processor 10 also obtains, from the transportation information database TDB in the transportation information data server 80, the relations between the transportation methods TM-1 to TM-r and the distances D1 to Dr corresponding to the combination of the production base location PB and the storage and sales base location SB obtained from the merchandise information database MDB in the merchandise information data server 60. The processor 10 further obtains, from the transportation intensity database BtDB in the intensity information data server 90, the transportation intensities But-1 to But-r corresponding respectively to the transportation methods TM-1 to TM-r.

After that, out of the distances D1 to Dr obtained, the processor 10 calculates a product of the distance D1 corresponding to the transportation method TM-1 and the transportation intensity But-1 corresponding to the transportation method TM-1. The processor 10 thus calculates the amount of carbon dioxide emitted when a unit weight of the merchandise is transported for the distance D1 using the transportation method TM-1. Similarly, the processor 10 calculates products of the distances D2 to Dr corresponding to the transportation methods TM-2 to TM-r and the transportation intensities But-2 to But-r corresponding to the transportation methods TM-2 to TM-r, respectively. The processor 10 thus calculates the amounts of carbon dioxide emitted when a unit mass of the merchandise is transported for the distances D2 to Dr using the transportation methods TM-2 to TM-r, respectively.

The processor 10 then calculates the sum of the calculated amounts of carbon dioxide emitted by transportation for the distances D1 to Dr using the respective transportation methods TM-1 to TM-r. This calculation result is equivalent to the amount of carbon dioxide emitted when a unit mass of the merchandise is transported from the production base location PB to the storage and sales base location SB. The processor 10 then calculates, as a transportation emission amount Et, a product of the calculation result on the amount of carbon dioxide emitted when a unit mass of the merchandise is transported from the production base location PB to the storage and sales base location SB and the merchandise weight MW of the printing apparatus corresponding to the merchandise code MC. This transportation emission amount Et is equivalent to the amount of carbon dioxide emitted when the printing apparatus corresponding to the merchandise code MC is transported from the production base location PB to the storage and sales base location SB. The processor 10 then stores the calculated transportation emission amount Et in the storage unit 50.

Next, calculation of the amount of carbon dioxide emitted in the print apparatus disposal stage is described. The processor 10 calculates the amount of carbon dioxide emissions associated with disposal of the materials included in the printing apparatus in the print apparatus disposal stage.

When a merchandise code MC identifying a printing apparatus for which to calculate a carbon dioxide emission amount is inputted to the processor 10 by a user operating the input unit 20, the processor 10 obtains, from the merchandise information database MDB in the merchandise information data server 60, the material codes Ma-1 to Ma-n stored in the material information MaI on the printing apparatus corresponding to the merchandise code MC and the material weights Maw-1 to Maw-n corresponding respectively to the material codes Ma-1 to Ma-n. The processor 10 also obtains, from the disposal intensity database BdDB in the intensity information data server 90, the disposal intensities Bud-1 to Bub-n corresponding respectively to the material codes Ma-1 to Ma-n obtained from the merchandise information database MDB in the merchandise information data server 60.

After that, out of the material weights Maw-1 to Maw-n obtained, the processor 10 calculates a product of the material weight Maw-1 corresponding to the material code Ma-1 and the disposal intensity Bud-1 corresponding to the material code Ma-1. The processor 10 thus calculates the amount of carbon dioxide emitted when the material corresponding to the material code Ma-1 is disposed of.

Similarly, the processor 10 calculates products of the material weights Maw-2 to Maw-n corresponding to the material codes Ma-2 to Ma-n and the disposal intensities Bud-2 to Bud-n corresponding to the material codes Ma-2 to Ma-n, respectively. The processor 10 thus calculates the amounts of carbon dioxide emitted when the materials corresponding to the respective material codes Ma-2 to Ma-n are disposed of.

The processor 10 then calculates, as a disposal emission amount Ed, the total sum of the calculated amounts of carbon dioxide emitted when the materials corresponding to the respective material codes Ma-1 to Ma-n are disposed of. This disposal emission amount Ed is equivalent to the amount of carbon dioxide emissions associated with disposal of the materials included in the printing apparatus. The processor 10 then stores the calculated disposal emission amount Ed in the storage unit 50.

The processor 10 then calculates, as a printing apparatus emission amount Epe, the sum of the material emission amount Ep, the processing emission amount Em, the manufacturing electric power emission amount Ee, the transportation emission amount Et, and the disposal emission amount Ed stored in the storage unit 50 and stores the printing apparatus emission amount Epe in the storage unit 50. This printing apparatus emission amount Epe calculated by the processor 10 is equivalent to the amount of carbon dioxide emissions associated with manufacturing and disposal of the printing apparatus.

3.2 Amount of Carbon Dioxide Emissions Associated with Manufacturing and Disposal of an Expendable

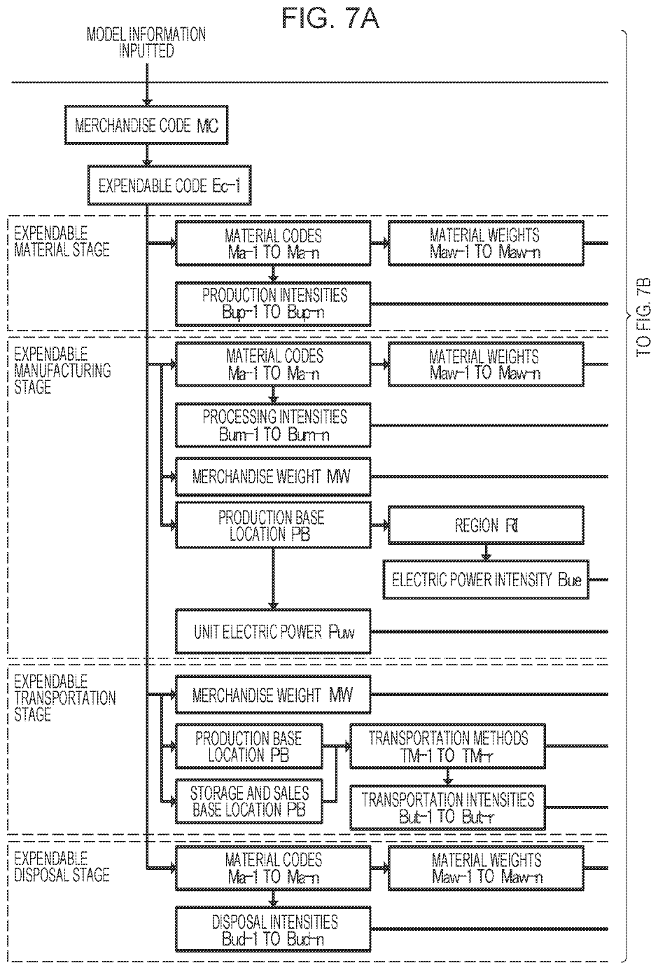

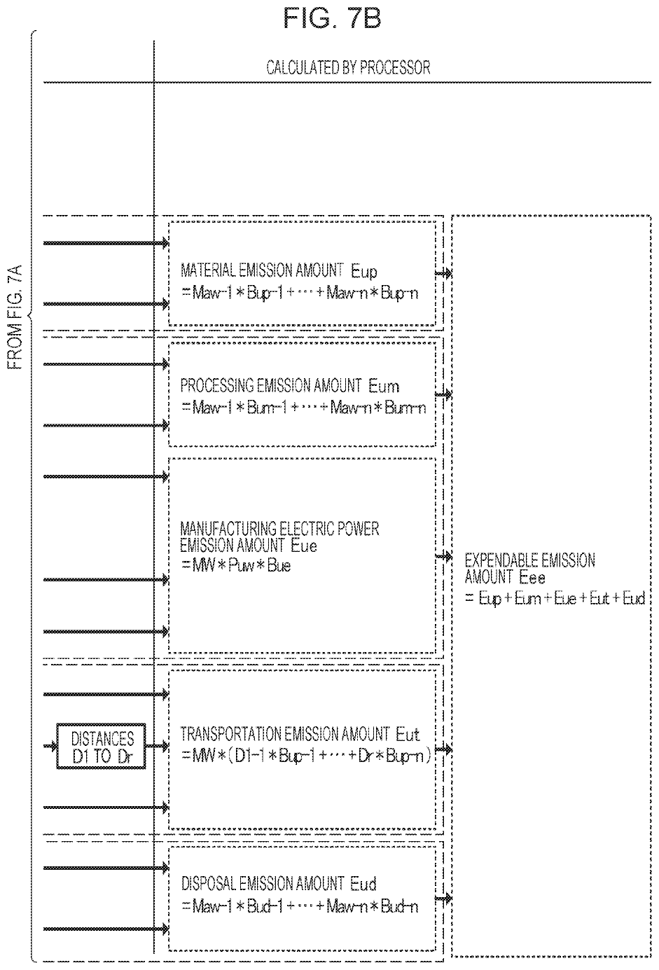

Next, a description is given of an example method, executed by the processor 10, for calculating the amount of carbon dioxide emissions associated with manufacturing and disposal of an expendable used for a printing apparatus. FIGS. 7A and 7B are diagrams showing an example of a method for calculating the amount of carbon dioxide emissions associated with manufacturing and disposal of an expendable used for a printing apparatus. As shown in FIGS. 7A and 7B, to calculate the amount of carbon dioxide emissions associated with manufacturing and disposal of an expendable used for a printing apparatus, the processor 10 calculates the amounts of carbon dioxide emitted in the respective following four stages: an expendable material stage, an expendable manufacturing stage, an expendable transportation stage, and an expendable disposal stage. Although the present embodiment shows an example where an expendable identified by the expendable code Ec-1 is the only expendable used for a printing apparatus, the number of expendables used for a printing apparatus is not limited to one, and there may be more than one expendable. When more than one expendable is used for a printing apparatus, the printing apparatus management system 1 calculates the amount of carbon dioxide emissions associated with manufacturing and disposal of each of the expendables by repeating similar calculation for each of the expendables.

First, calculation of the amount of carbon dioxide emitted in the expendable material stage is described. The processor 10 calculates the amount of carbon dioxide emissions associated with production of materials included in the expendable used for the printing apparatus in the expendable material stage.

When a merchandise code MC identifying a printing apparatus for which to calculate a carbon dioxide emission amount is inputted to the processor 10 by a user operating the input unit 20, the processor 10 obtains, from the merchandise information database MDB in the merchandise information data server 60, an expendable code Ec-1 under the printing apparatus corresponding to the merchandise code MC. The processor 10 thus obtains the merchandise code MC referred to by the expendable code Ec-1.

Then, by obtaining the expendable's merchandise code MC referred to by the expendable code Ec-1, the processor 10 obtains, from the merchandise information database MDB in the merchandise information data server 60, the material codes Ma-1 to Ma-n stored in the material information MaI on the expendable corresponding to the merchandise code MC and the material weights Maw-1 to Maw-n corresponding respectively to the material codes Ma-1 to Ma-n. The processor 10 also obtains, from the production intensity database BpDB in the intensity information data server 90, the production intensities Bup-1 to Bup-n corresponding respectively to the material codes Ma-1 to Ma-n obtained from the merchandise information database MDB in the merchandise information data server 60.

After that, out of the material weights Maw-1 to Maw-n obtained, the processor 10 calculates a product of the material weight Maw-1 corresponding to the material code Ma-1 and the production intensity Bup-1 corresponding to the material code Ma-1. The processor 10 thus calculates the amount of carbon dioxide emitted when the material corresponding to the material code Ma-1 is produced.

Similarly, the processor 10 calculates products of the material weights Maw-2 to Maw-n corresponding to the material codes Ma-2 to Ma-n and the production intensities Bup-2 to Bup-n corresponding to the material codes Ma-2 to Ma-n, respectively. The processor 10 thus calculates the amounts of carbon dioxide emitted when the materials corresponding to the respective material codes Ma-2 to Ma-n are produced.

The processor 10 then calculates, as a material emission amount Eup, the sum of the calculated amounts of carbon dioxide emitted when the materials corresponding to the respective material codes Ma-1 to Ma-n are produced. This material emission amount Eup is equivalent to the amount of carbon dioxide emissions associated with production of materials included in the expendable used for the printing apparatus. The processor 10 then stores the calculated material emission amount Eup in the storage unit 50.

Next, calculation of the amount of carbon dioxide emitted in the expendable manufacturing stage is described. The processor 10 calculates the amount of carbon dioxide emissions associated with manufacturing of the expendable used for the printing apparatus in the expendable manufacturing stage. To this end, as the amount of carbon dioxide emissions associated with manufacturing of the expendable used for the printing apparatus, the processor 10 calculates the amount of carbon dioxide emissions associated with processing of materials corresponding to the respective material codes Ma-1 to Ma-n included in the expendable and the amount of carbon dioxide emitted in accordance with the amount of electric power used to manufacture the expendable.

First, a description is given of calculation of the amount of carbon dioxide emissions associated with processing of materials corresponding to the respective material codes Ma-1 to Ma-n included in an expendable used for a printing apparatus. When a merchandise code MC identifying a printing apparatus for which to calculate a carbon dioxide emission amount is inputted to the processor 10 by a user operating the input unit 20, the processor 10 obtains, from the merchandise information database MDB in the merchandise information data server 60, the expendable code Ec-1 under the printing apparatus corresponding to the merchandise code MC. Then, the processor 10 obtains the merchandise code MC referred to by the expendable code Ec-1.

By obtaining the expendable's merchandise code MC referred to by the expendable code Ec-1, the processor 10 obtains, from the merchandise information database MDB in the merchandise information data server 60, the material codes Ma-1 to Ma-n stored in the material information MaI on the expendable corresponding to the merchandise code MC and the material weights Maw-1 to Maw-n corresponding respectively to the material codes Ma-1 to Ma-n. The processor 10 also obtains, from the processing intensity database BmDB in the intensity information data server 90, the processing intensities Bum-1 to Bum-n corresponding respectively to the material codes Ma-1 to Ma-n obtained from the merchandise information database MDB in the merchandise information data server 60.

After that, out of the material weights Maw-1 to Maw-n obtained, the processor 10 calculates a product of the material weight Maw-1 corresponding to the material code Ma-1 and the processing intensity Bum-1 corresponding to the material code Ma-1. The processor 10 thus calculates the amount of carbon dioxide emitted when the material corresponding to the material code Ma-1 is processed. Similarly, the processor 10 calculates products of the material weights Maw-2 to Maw-n corresponding to the material codes Ma-2 to Ma-n and the processing intensities Bum-2 to Bum-n corresponding to the material codes Ma-2 to Ma-n, respectively. The processor 10 thus calculates the amounts of carbon dioxide emitted when the materials corresponding to the respective material codes Ma-2 to Ma-n are processed.

The processor 10 then calculates, as a processing emission amount Eum, the sum of the calculated amounts of carbon dioxide emitted by processing of the materials corresponding to the respective material codes Ma-1 to Ma-n. This processing emission amount Eum is equivalent to the amount of carbon dioxide emissions associated with processing of the materials included in the expendable used for the printing apparatus. The processor 10 then stores the calculated processing emission amount Eum in the storage unit 50.

Next, a description is given of calculation of the amount of carbon dioxide emitted in accordance with the amount of electric power used to manufacture an expendable used for a printing apparatus. When a merchandise code MC identifying a printing apparatus for which to calculate a carbon dioxide emission amount is inputted to the processor 10 by a user operating the input unit 20, the processor 10 obtains, from the merchandise information database MDB in the merchandise information data server 60, the expendable code Ec-1 under the printing apparatus corresponding to the merchandise code MC. Then, the processor 10 obtains the merchandise code MC referred to by the expendable code Ec-1.

By obtaining the expendable's merchandise code MC referred to by the expendable code Ec-1, the processor 10 obtains, from the merchandise information database MDB in the merchandise information data server 60, the merchandise weight MW and the production base location PB of the expendable corresponding to the merchandise code MC. The processor 10 also obtains, from the base location electric power information database PDB in the base location electric power information data server 70, the unit electric power amount Puw corresponding to the production base location PB obtained from the merchandise information database MDB in the merchandise information data server 60. The processor 10 further obtains, from the electric power intensity database BeDB in the intensity information data server 90, the electric power intensity Bue corresponding to the region RI connected to the production base location PB obtained from the merchandise information database MDB in the merchandise information data server 60.

The processor 10 then calculates, as a manufacturing electric power emission amount Eue, a product of the merchandise weight MW, the unit electric power amount Puw, and the electric power intensity Bue obtained. This manufacturing electric power emission amount Eue is equivalent to the amount of carbon dioxide emitted in accordance with the amount of electric power used to manufacture the expendable used for the printing apparatus. The processor 10 then stores the calculated manufacturing electric power emission amount Eue in the storage unit 50.

Next, calculation of the amount of carbon dioxide emitted in the expendable transportation stage is described. The processor 10 calculates the amount of carbon dioxide emissions associated with transportation of the expendable used for the printing apparatus in the expendable transportation stage.

When a merchandise code MC identifying a printing apparatus for which to calculate a carbon dioxide emission amount is inputted to the processor 10 by a user operating the input unit 20, the processor 10 obtains, from the merchandise information database MDB in the merchandise information data server 60, the expendable code Ec-1 under the printing apparatus corresponding to the merchandise code MC. The processor 10 then obtains the merchandise code MC referred to by the expendable code Ec-1.

By obtaining the expendable's merchandise code MC referred to by the expendable code Ec-1, the processor 10 obtains, from the merchandise information database MDB in the merchandise information data server 60, the merchandise weight MW, the production base location PB, and the storage and sales base location SB of the expendable corresponding to the merchandise code MC. The processor 10 also obtains, from the transportation information database TDB in the transportation information data server 80, the relations between the transportation methods TM-1 to TM-r and the distances D1 to Dr corresponding to the combination of the production base location PB and the storage and sales base location SB obtained from the merchandise information database MDB in the merchandise information data server 60. The processor 10 further obtains, from the transportation intensity database BtDB in the intensity information data server 90, the transportation intensities But-1 to But-r corresponding respectively to the transportation methods TM-1 to TM-r.

After that, out of the distances D1 to Dr obtained, the processor 10 calculates a product of the distance D1 corresponding to the transportation method TM-1 and the transportation intensity But-1 corresponding to the transportation method TM-1. The processor 10 thus calculates the amount of carbon dioxide emitted when a unit weight of the merchandise is transported for the distance D1 by the transportation method TM-1. Similarly, the processor 10 calculates products of the distances D2 to Dr corresponding to the transportation methods TM-2 to TM-r and the transportation intensities But-2 to But-r corresponding to the transportation methods TM-2 to TM-r, respectively. The processor 10 thus calculates the amounts of carbon dioxide emitted when a unit mass of the merchandise is transported for the distances D2 to Dr by the transportation methods TM-2 to TM-r, respectively.

The processor 10 then calculates the sum of the calculated amounts of carbon dioxide emitted by transportation for the distances D1 to Dr using the respective transportation methods TM-1 to TM-r. This calculation result is equivalent to the amount of carbon dioxide emitted when a unit mass of the merchandise is transported from the production base location PB to the storage and sales base location SB. The processor 10 then calculates, as a transportation emission amount Eut, a product of the calculation relation result on the amount of carbon dioxide emitted when a unit mass of the merchandise is transported from the production base location PB to the storage and sales base location SB and the merchandise weight MW of the expendable corresponding to the merchandise code MC. This transportation emission amount Et is equivalent to the amount of carbon dioxide emitted when the expendable corresponding to the merchandise code MC is transported from the production base location PB to the storage and sales base location SB. The processor 10 then stores the calculated transportation emission amount Eut in the storage unit 50.

Next, calculation of the amount of carbon dioxide emitted in the expendable disposal stage is described. The processor 10 calculates the amount of carbon dioxide emissions associated with disposal of the materials included in the expendable used for the printing apparatus in the expendable disposal stage.

When a merchandise code MC identifying a printing apparatus for which to calculate a carbon dioxide emission amount is inputted to the processor 10 by a user operating the input unit 20, the processor 10 obtains, from the merchandise information database MDB in the merchandise information data server 60, the expendable code Ec-1 under the printing apparatus corresponding to the merchandise code MC. The processor 10 then obtains the merchandise code MC referred to by the expendable code Ec-1.

By obtaining the expendable's merchandise code MC referred to by the expendable code Ec-1, the processor 10 obtains, from the merchandise information database MDB in the merchandise information data server 60, the material codes Ma-1 to Ma-n stored in the material information MaI on the expendable corresponding to the merchandise code MC and the material weights Maw-1 to Maw-n corresponding respectively to the material codes Ma-1 to Ma-n. The processor 10 also obtains, from the disposal intensity database BdDB in the intensity information data server 90, the disposal intensities Bud-1 to Bub-n corresponding respectively to the material codes Ma-1 to Ma-n obtained from the merchandise information database MDB in the merchandise information data server 60.

After that, out of the material weights Maw-1 to Maw-n obtained, the processor 10 calculates a product of the material weight Maw-1 corresponding to the material code Ma-1 and the disposal intensity Bud-1 corresponding to the material code Ma-1. The processor 10 thus calculates the amount of carbon dioxide emitted when the material corresponding to the material code Ma-1 is disposed of.

Similarly, the processor 10 calculates products of the material weights Maw-2 to Maw-n corresponding to the material codes Ma-2 to Ma-n and the disposal intensities Bud-2 to Bud-n corresponding to the material codes Ma-2 to Ma-n, respectively. The processor 10 thus calculates the amounts of carbon dioxide emitted when the materials corresponding to the respective material codes Ma-2 to Ma-n are disposed of.

The processor 10 then calculates, as a disposal emission amount Eud, the total sum of the calculated amounts of carbon dioxide emitted when the materials corresponding to the respective material codes Ma-1 to Ma-n are disposed of. This disposal emission amount Eud is equivalent to the amount of carbon dioxide emissions associated with disposal of the materials included in the expendable used for the printing apparatus. The processor 10 then stores the calculated disposal emission amount Eud in the storage unit 50.

The processor 10 then calculates, as an expendable emission amount Eee, the sum of the material emission amount Eup, the processing emission amount Eum, the manufacturing electric power emission amount Eue, the transportation emission amount Eut, and the material emission amount Eup stored in the storage unit 50, and stores the expendable emission amount Eee in the storage unit 50. This expendable emission amount Eee calculated by the processor 10 is equivalent to the amount of carbon dioxide emissions associated with manufacturing and disposal of the expendable.

### 3.3 Calculation of a Lifetime Carbon Dioxide Emission Amount for the Printing Apparatus

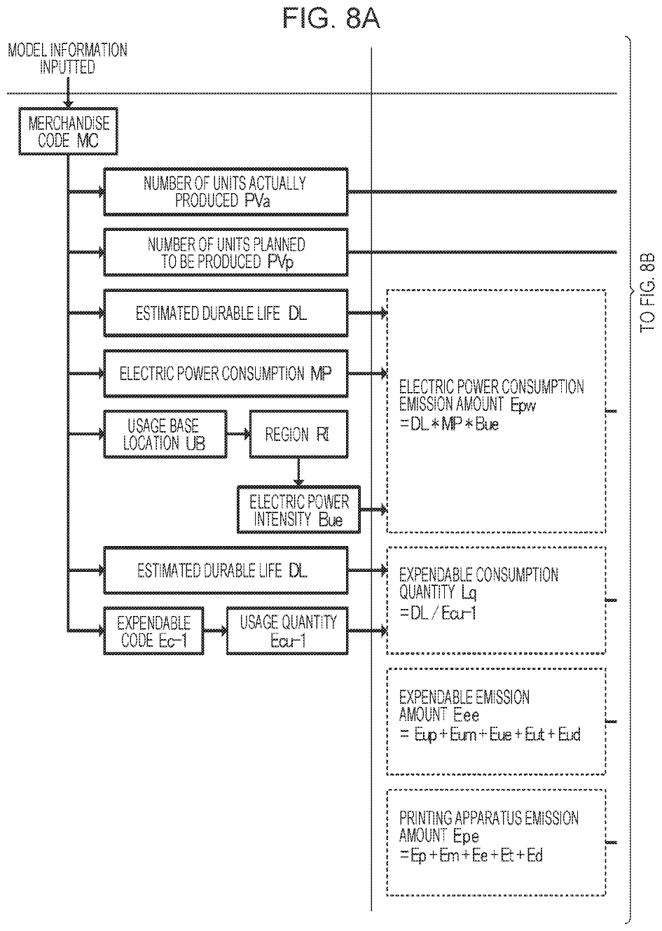

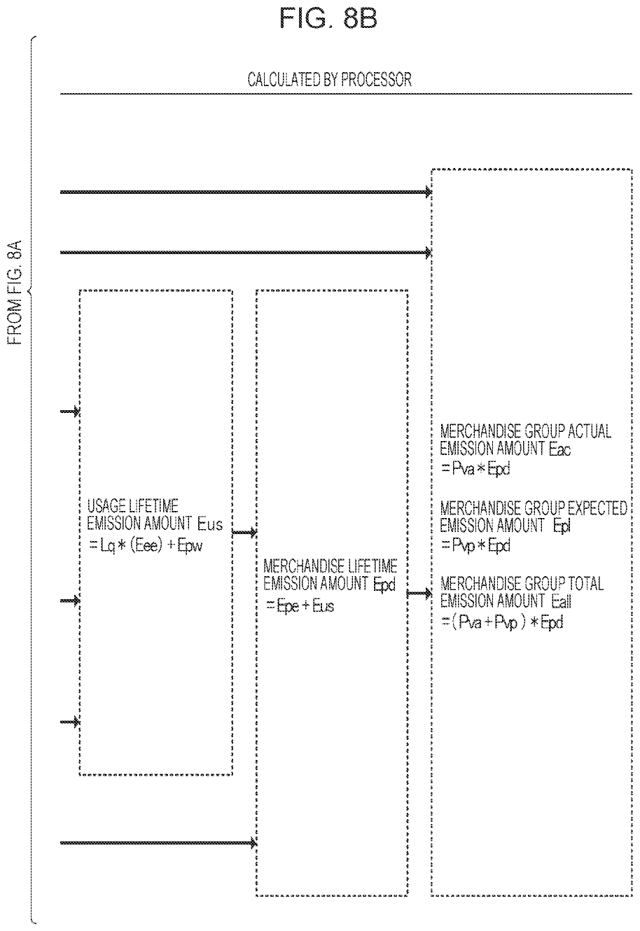

Next, a description of an example of a method, executed by the processor 10, for calculating the amount of carbon dioxide emitted by a printing apparatus in its lifetime. FIGS. 8A and 8B are diagrams showing an example of a method for calculating the amount of carbon dioxide emitted by a printing apparatus in its lifetime. As shown in FIGS. 8A and 8B, the processor 10 calculates the amount of carbon dioxide emitted by a printing apparatus in its lifetime based not only the printing apparatus emission amount Epe indicating the amount of carbon dioxide emissions associated with manufacturing and disposal of the printing apparatus and the expendable emission amount Eee indicating the amount of carbon dioxide emissions associated with manufacturing and disposal of the expendable which are described above, but also the amount of carbon dioxide emissions in accordance with the amount of electric power consumed by the printing apparatus in its lifetime and the usage quantity of the expendable that the printing apparatus uses in its lifetime.

To that end, to describe calculation of the amount of carbon dioxide emitted by the printing apparatus in its lifetime, a specific example of how to calculate the amount of carbon dioxide emissions in accordance with the amount of electric power consumed by the printing apparatus in its lifetime and the usage quantity of the expendable that the printing apparatus uses in its lifetime is described first.

First, a description is given of an example of a method for calculating the amount of carbon dioxide emissions in accordance with the amount of electric power consumed by the printing apparatus in its lifetime. When a merchandise code MC identifying a printing apparatus for which to calculate a lifetime carbon dioxide emission amount is inputted to the processor 10 by a user operating the input unit 20, the processor 10 obtains, from the merchandise information database MDB in the merchandise information data server 60, the estimated durable life DL, the electric power consumption MP, and the usage base location UB of the printing apparatus corresponding to the merchandise code MC. In this event, of the estimated durable life DL stored in the merchandise information database MDB in the merchandise information data server 60, the processor 10 obtains information based on a designed expected life calculated when the merchandise was designed, which is, for example, information on a durable period expected after the production of the printing apparatus. The processor 10 also obtains, from the electric power intensity database BeDB in the intensity information data server 90, the electric power intensity Bue corresponding to the region RI connected to the usage base location UB obtained from the merchandise information database MDB in the merchandise information data server 60.

The processor 10 then calculates, as an electric power consumption emission amount Epw, a product of the estimated durable life DL, the electric power consumption MP, and the electric power intensity Bue obtained. This electric power consumption emission amount Epw is equivalent to the amount of carbon dioxide emissions in accordance with the amount of electric power consumed by the printing apparatus in its lifetime. The processor 10 then stores the calculated electric power consumption emission amount Epw in the storage unit 50.

Next, a description is given of an example of a method for calculating the usage quantity of the expendable that the printing apparatus consumes in its lifetime. The usage quantity of the expendable identified by the expendable code Ec-1 is used as an example below. When a merchandise code MC identifying a printing apparatus for which to calculate a lifetime carbon dioxide emission amount is inputted to the processor 10 by a user operating the input unit 20, the processor 10 obtains, from the merchandise information database MDB in the merchandise information data server 60, the estimated durable life DL of the printing apparatus corresponding to the merchandise code MC and the expendable usage quantity Ecu-1 connected to the expendable code Ec-1. In this event, as the estimated durable life DL stored in the merchandise information database MDB in the merchandise information data server 60, the processor 10 obtains information on, e.g., the number of sheets of medium on which the printing apparatus is capable of executing printing processing, and as the expendable usage quantity Ecu-1 connected to the expendable code Ec-1 stored in the merchandise information database MDB in the merchandise information data server 60, the processor 10 obtains information on, e.g., the number of sheets of media that the printing apparatus is capable of printing when the expendable is used for the printing apparatus identified by the merchandise code MC.

The processor 10 then calculates an expendable consumption quantity Lq by dividing the obtained estimated durable life DL by the obtained expendable usage quantity Ecu-1. This expendable consumption quantity Lq is equivalent to the usage quantity of the expendable that the printing apparatus consumes in its lifetime. The processor 10 then stores the calculated expendable consumption quantity Lq in the storage unit 50.

The processor 10 then calculates the amount of carbon dioxide emitted by the printing apparatus in its lifetime based on the printing apparatus emission amount Epe, the expendable emission amount Eee, the electric power consumption emission amount Epw, and the expendable consumption quantity Lq stored in the storage unit 50.

Specifically, the processor 10 calculates the amount of carbon dioxide emitted by the expendables that the printing apparatus uses in its life time by calculating a product of the expendable emission amount Eee and the expendable consumption quantity Lq and calculates a usage lifetime emission amount Eus by adding the electric power consumption emission amount Epw to the product of the expendable emission amount Eee and the expendable consumption quantity Lq. The amount of carbon dioxide emitted in the period of time in which the printing apparatus is being used is attributed to the amount of carbon dioxide emissions associated with manufacturing and disposal of the expendable used for the printing apparatus and the amount of carbon dioxide emissions associated with generation of electric power supplied to the printing apparatus. In other words, the usage lifetime emission amount Eus calculated by the processor 10 is equivalent to the amount of carbon dioxide emitted in a usage period of the printing apparatus of the lifetime of the printing apparatus. The processor 10 then stores the calculated usage lifetime emission amount Eus in the storage unit 50.

The processor 10 also calculates, as a merchandise lifetime emission amount Epd, a value obtained by adding the printing apparatus emission amount Epe to the calculated usage lifetime emission amount Eus. The printing apparatus emission amount Epe is equivalent to the amount of carbon dioxide emissions associated with manufacturing and disposal of the printing apparatus. Thus, the merchandise lifetime emission amount Epd calculated by the processor 10 is equivalent to the amount of carbon dioxide emitted by the printing apparatus in its lifetime, including the amount of carbon dioxide emitted not only in a usage period of the printing apparatus, but also in manufacturing of the printing apparatus and disposal of the printing apparatus. The processor 10 then stores the calculated merchandise lifetime emission amount Epd in the storage unit 50.

In other words, the processor 10 in the printing apparatus management system 1 calculates, as the amount of carbon dioxide emitted by the printing apparatus in its lifetime, the merchandise lifetime emission amount Epd including the amount of carbon dioxide emitted by the expendable in its lifetime and the printing apparatus emission amount Epe not including the amount of carbon dioxide emitted by the expendable in its lifetime.

The processor 10 further obtains, from the merchandise information database MDB in the merchandise information data server 60, the number of units actually produced PVa and the number of units planned to be produced PVp corresponding to the merchandise code MC of the printing apparatus for which to calculate a carbon dioxide emission amount. The processor 10 then calculates, as an actual total emission amount Eac, a product of the merchandise lifetime emission amount Epd and the number of units actually produced PVa and calculates, as an expected total emission amount Epl, a product of the merchandise lifetime emission amount Epd and the number of units planned to be produced PVp. The processor 10 then calculates, as a lifetime total emission amount Eall, a value obtained by adding the product of the merchandise lifetime emission amount Epd and the number of units planned to be produced PVp to the product of the merchandise lifetime emission amount Epd and the number of units actually produced PVa.

In other words, the calculation information includes the number of units actually produced PVa and the number of units planned to be produced PVp of the printing apparatus, and the processor 10 calculates the amount of carbon dioxide emitted by a group of merchandises including the printing apparatus based on the amount of carbon dioxide emitted by the printing apparatus in its lifetime and at least one of the number of units actually produced PVa and the number of units planned to be produced PVp.

As described earlier, the number of units actually produced PVa includes information on the number of units of the merchandise identified by the merchandise code MC that are actually produced, and the number of units planned to be produced PVp includes information on the number of units of the merchandise identified by the merchandise code MC that are expected to be produced in the future. In other words, the actual total emission amount Eac is equivalent to an actual performance value indicating the amount of carbon dioxide actually emitted by the group of merchandises identified by the merchandise codes MC, and the expected total emission amount Epl is equivalent to a value indicating the amount of carbon dioxide expected to be emitted in the future by the group of merchandises identified by the merchandise codes MC. Then, the lifetime total emission amount Eall is equivalent to a value indicating the amount of carbon dioxide emitted by the group of merchandises identified by the merchandise codes MC in their lifetimes. Thus, the user can know the details of how the measures are effective.

As thus described, the printing apparatus management system 1 of the present embodiment is the printing apparatus management system 1 that calculates the amount of carbon dioxide emitted by a printing apparatus in its lifetime and includes the processor 10 that calculates, based on calculation information, the amount of carbon dioxide emitted by the printing apparatus in its lifetime and the output unit 30 that outputs calculation results obtained by the processor 10, and the calculation information includes the material weights Maw indicating the usage quantities of the materials forming the printing apparatus and corresponding to the material codes Ma, the production intensities Bup indicating unit amounts of carbon dioxide emissions associated with production of the materials of the printing apparatus corresponding to the material codes Ma for the printing apparatus, the disposal intensities Bud indicating unit amounts of carbon dioxide emissions associated with disposal of the materials of the printing apparatus corresponding to the material codes Ma, the merchandise weight MW of the printing apparatus, the processing intensity Bum and the electric power intensity Bue indicating a unit amount of carbon dioxide emissions associated with production of the printing apparatus, the distance D for which the printing apparatus is transported using the transportation method TM, the transportation intensity But indicating a unit amount of carbon dioxide emissions associated with transportation of the printing apparatus using the transportation method TM, the type of the expendable corresponding to the expendable code Ec and used for the printing apparatus, the usage quantity Ecu of the expendable corresponding to the expendable code Ec of the expendable for the printing apparatus, the material weights Maw indicating the usage quantities of the materials corresponding to the material codes Ma forming the expendable corresponding to the expendable code Ec of the expendable for the printing apparatus, the production intensities Bup indicating the amounts of carbon dioxide emissions associated with production of the materials corresponding to the respective material codes Ma forming the expendable corresponding to the expendable code Ec of the expendable for the printing apparatus, the disposal intensities Bud indicating unit amounts of carbon dioxide emissions associated with disposal of the materials corresponding to the respective material codes Ma forming the expendable corresponding to the expendable code Ec of the expendable for the printing apparatus, the merchandise weight MW of the expendable corresponding to the expendable code Ec of the expendable for the printing apparatus, the processing intensity Bum and the electric power intensity Bue indicating a unit amount of carbon dioxide emissions associated with production of the expendable corresponding to the expendable code Ec of the expendable for the printing apparatus, the distance D for which the expendable corresponding to the expendable code Ec of the expendable for the printing apparatus is transported using the transportation method TM, the transportation intensity But indicating a unit amount of carbon dioxide emissions associated with transportation of the expendable corresponding to the expendable code Ec of the expendable for the printing apparatus using the transportation method TM, the electric power consumption MP of the printing apparatus, and the electric power intensities Bue indicating a unit amount of carbon dioxide emissions per amount of electric power.

### 3.4 Production of a Carbon Dioxide Emission Report

In the printing apparatus management system 1 thus configured, information related to carbon dioxide emitted by a printing apparatus calculated by the processor 10 is stored in the storage unit 50. Then, in response to a user's operation of the input unit 20, the processor 10 appropriately extracts information related to carbon dioxide emitted by the printing apparatus stored in the storage unit 50 and causes the report generation unit 40 to generate a carbon dioxide emission report according to the extracted information. Information desired by the user can thus be extracted as needed.

Here, a printing apparatus corresponding to any one of the merchandise codes MC included in the merchandise information database MDB is an example of the first printing apparatus, a plurality of printing apparatuses corresponding to any ones of the merchandise codes MC included in the merchandise information database MDB and including the first printing apparatus is an example of the first printing apparatus group, the similar model code MCs connected to the merchandise code MC identifying the printing apparatus which is the first printing apparatus is an example of the related-model information, a printing apparatus identified by the similar model code MCs connected to the merchandise code MC identifying the printing apparatus which is the first printing apparatus is an example of the second printing apparatus.

The material code Ma connected to the merchandise code MC identifying the printing apparatus which is the first printing apparatus is an example of the first material, the material weight Maw connected to the material code Ma under the merchandise code MC identifying the merchandise code MC identifying the printing apparatus which is the first printing apparatus is an example of the usage quantity of the first material, the production intensity Bup corresponding to the material code Ma under the merchandise code MC identifying the printing apparatus which is the first printing apparatus is an example of the first emission coefficient, the disposal intensity Bud corresponding to the material code Ma under the merchandise code MC identifying the printing apparatus which is the first printing apparatus is an example of the second emission coefficient, the merchandise weight MW of the merchandise code MC identifying the printing apparatus which is the first printing apparatus is an example of the weight of the first printing apparatus, the processing intensity Bum corresponding to the material code Ma under the merchandise code MC identifying the printing apparatus which is the first printing apparatus is an example of the third emission coefficient, the transportation method TM for transporting the printing apparatus which is the first printing apparatus is an example of the first transportation unit, the distance D connected to the transportation method TM for transporting the printing apparatus which is the first printing apparatus is an example of the first transportation distance, and the transportation intensity But indicating a unit amount of carbon dioxide emitted by using the transportation method TM for transporting the printing apparatus which is the first printing apparatus is an example of the fourth emission coefficient.

The expendable identified by the expendable code Ec connected to the merchandise code MC identifying the printing apparatus which is the first printing apparatus is an example of the expendable used for the printing apparatus, the usage quantity Ecu connected to the expendable code Ec under the merchandise code MC identifying the printing apparatus which is the first printing apparatus is an example of the quantity of the expendable used, the material corresponding to the material code Ma connected to the expendable's merchandise code MC referred to by the expendable code Ec under the merchandise code MC identifying the printing apparatus which is the first printing apparatus is an example of the second material, the material weight Maw connected to the material code Ma under the expendable's merchandise code MC referred to by the expendable code Ec under the merchandise code MC identifying the printing apparatus which is the first printing apparatus is an example of the usage quantity of the second material, the production intensity Bup corresponding to the material code Ma under the expendable's merchandise code MC referred to by the expendable code Ec under the merchandise code MC identifying the printing apparatus which is the first printing apparatus is an example of the fifth emission coefficient, the disposal intensity Bud corresponding to the material code Ma under the expendable's merchandise code MC referred to by the expendable code Ec under the merchandise code MC identifying the printing apparatus which is the first printing apparatus is an example of the sixth emission coefficient, the merchandise weight MW of the material code Ma under the expendable's merchandise code MC referred to by the expendable code Ec under the merchandise code MC identifying the printing apparatus which is the first printing apparatus is an example of the weight of the expendable, the processing intensity Bum corresponding to the material code Ma under the expendable's merchandise code MC referred to by the expendable code Ec under the merchandise code MC identifying the printing apparatus which is the first printing apparatus is an example of the seventh emission coefficient, the transportation method TM for transporting the expendable referred to by the expendable code Ec under the merchandise code MC identifying the printing apparatus which is the first printing apparatus is an example of the second transportation unit, the distance D connected to the transportation method TM for transporting the expendable referred to by the expendable code Ec under the merchandise code MC identifying the printing apparatus which is the first printing apparatus is an example of the second transportation distance, and the transportation intensity But indicating a unit amount of carbon dioxide emitted by using the transportation method TM for transporting the expendable referred to by the expendable code Ec under the merchandise code MC identifying the printing apparatus which is the first printing apparatus is an example of the eighth emission coefficient.

Also, the electric power consumption MP connected to the merchandise code MC identifying the printing apparatus which is the first printing apparatus is an example of the amount of electric power consumed by the first printing apparatus, and the electric power intensity Bue indicating a unit amount of carbon dioxide emissions for the electric power consumption MP connected to the merchandise code MC identifying the printing apparatus which is the first printing apparatus is an example of the ninth emission coefficient.

The information connected to the merchandise code MC identifying the printing apparatus which is the first printing apparatus is an example of the first calculation information, and the information connected to the merchandise code MC identifying the printing apparatus which is the second printing apparatus is an example of the second calculation information.

Also, the output unit 30 is an example of the notification unit, at least one of the number of units actually produced PVa and the number of units planned to be produced PVp is an example of the transfer quantity information, the merchandise lifetime emission amount Epd is an example of the first emission amount, and the usage lifetime emission amount Eus is an example of the second emission amount.

Also, the merchandise information database MDB storing the merchandise codes MC is an example of the first database, the production intensity database BpDB storing the production intensities Bup and the disposal intensity database BdDB storing the disposal intensities Bud is an example of the second database, the processing intensity database BmDB storing the processing intensities Bum, the electric power intensity database BeDB storing the electric power intensities Bue, and the transportation information database TDB are an example of the third database, the transportation intensity database BtDB storing the transportation intensities But is an example of the fourth database, and the electric power intensity database BeDB storing the electric power intensities Bue is an example of the fifth database.

### 4. Advantageous Effects

As thus described, in the printing apparatus management system 1 of the present embodiment, the processor 10 calculates the amount of carbon dioxide emitted by a printing apparatus in its lifetime from the production, the usage, to the disposal of the printing apparatus based on calculation information, and the output unit 30 outputs the carbon dioxide emission amount, the calculation information including the material weights Maw indicating the usage quantities of the materials corresponding to the material codes Ma forming the printing apparatus, the production intensities Bup indicating unit amounts of carbon dioxide emissions associated with production of the materials of the printing apparatus corresponding to the material codes Ma, the disposal intensities Bud indicating unit amounts of carbon dioxide emissions associated with disposal of the materials of the printing apparatus corresponding to the material codes Ma, the merchandise weight MW of the printing apparatus, the processing intensity Bum and the electric power intensity Bue indicating a unit amount of carbon dioxide emissions associated with production of the printing apparatus, the distance D for which the printing apparatus is transported using the transportation method TM, the transportation intensity But indicating a unit amount of carbon dioxide emissions associated with transportation of the printing apparatus using the transportation method TM, the type of the expendable corresponding to the expendable code Ec and used for the printing apparatus, the usage quantity Ecu of the expendable corresponding to the expendable code Ec of the expendable for the printing apparatus, the material weights Maw indicating the usage quantities of the materials corresponding to the material codes Ma forming the expendable corresponding to the expendable code Ec of the expendable for the printing apparatus, the production intensities Bup indicating the amount of carbon dioxide emissions associated with production of the materials corresponding to the respective material codes Ma forming the expendable corresponding to the expendable code Ec of the expendable for the printing apparatus, the disposal intensity Bud indicating a unit amount of carbon dioxide emissions associated with production of the materials corresponding to the respective material codes Ma forming the expendable corresponding to the expendable code Ec of the expendable for the printing apparatus, the merchandise weight MW of the expendable corresponding to the expendable code Ec of the expendable for the printing apparatus, the processing intensity Bum and the electric power intensity Bue indicating a unit amount of carbon dioxide emissions associated with production of the expendable corresponding to the expendable code Ec of the expendable for the printing apparatus, the distance D for which the expendable corresponding to the expendable code Ec of the expendable for the printing apparatus is transported using the transportation method TM, the transportation intensity But indicating a unit amount of carbon dioxide emissions associated with transportation of the expendable corresponding to the expendable code Ec of the expendable for the printing apparatus using the transportation method TM, the electric power consumption MP of the printing apparatus, and the electric power intensities Bue indicating a unit amount of carbon dioxide emissions per amount of electric power.

In this way, the printing apparatus management system 1 of the present embodiment can calculate the amount of carbon dioxide emitted by a printing apparatus in its lifetime in detail, and meanwhile, the manufacturer of the printing apparatus can know the amount of carbon dioxide emitted by the printing apparatus in its lifetime and thus can take appropriate measures for the printing apparatus in order to reduce its carbon dioxide emission amount. As a result, use of the printing apparatus management system 1 of the present embodiment enables printing apparatuses putting even less load on the global environment to be introduced to the market. Thus, recent demands for reduced environmental load can be met.

In a method for producing a carbon dioxide emission amount report by using the printing apparatus management system 1 of the present embodiment, the processor 10 obtains calculation information and calculates, based on the calculation information obtained, the amount of carbon dioxide emitted by a printing apparatus as a merchandise in its lifetime, including the production, the usage, to the disposal of the printing apparatus, the calculation information including the material weights Maw indicating the usage quantities of the materials corresponding to the material codes Ma forming the printing apparatus as a merchandise, the production intensities Bup indicating unit amounts of carbon dioxide emissions associated with production of the materials of the printing apparatus as a merchandise corresponding to the material codes Ma, the disposal intensities Bud indicating unit amounts of carbon dioxide emissions associated with disposal of the materials of the printing apparatus as a merchandise corresponding to the material codes Ma, the merchandise weight MW of the printing apparatus as a merchandise, the processing intensity Bum and the electric power intensity Bue indicating a unit amount of carbon dioxide emissions associated with production of the printing apparatus as a merchandise, the distance D for which the printing apparatus as a merchandise is transported using the transportation method TM, the transportation intensity But indicating a unit amount of carbon dioxide emissions associated with transportation of the printing apparatus using the transportation method TM, the type of the expendable corresponding to the expendable code Ec and used for the printing apparatus as a merchandise, the usage quantity Ecu of the expendable corresponding to the expendable code Ec of the expendable for the printing apparatus as a merchandise, the material weights Maw indicating the usage quantities of the materials corresponding to the material codes Ma forming the expendable corresponding to the expendable code Ec of the expendable for the printing apparatus as a merchandise, the production intensities Bup indicating the amount of carbon dioxide emissions associated with production of the materials corresponding to the respective material codes Ma forming the expendable corresponding to the expendable code Ec of the expendable for the printing apparatus as a merchandise, the disposal intensity Bud indicating a unit amount of carbon dioxide emissions associated with production of the materials corresponding to the respective material codes Ma forming the expendable corresponding to the expendable code Ec of the expendable for the printing apparatus as a merchandise, the merchandise weight MW of the expendable corresponding to the expendable code Ec of the expendable for the printing apparatus as a merchandise, the processing intensity Bum and the electric power intensity Bue indicating a unit amount of carbon dioxide emissions associated with production of the expendable corresponding to the expendable code Ec of the expendable for the printing apparatus, the distance D for which the expendable corresponding to the expendable code Ec of the expendable for the printing apparatus as a merchandise is transported using the transportation method TM, the transportation intensity But indicating a unit amount of carbon dioxide emissions associated with transportation of the expendable corresponding to the expendable code Ec of the expendable for the printing apparatus using the transportation method TM, the electric power consumption MP of the printing apparatus as a merchandise, and the electric power intensities Bue indicating a unit amount of carbon dioxide emissions per amount of electric power. A carbon dioxide emission amount report stating the calculated carbon dioxide emission amount is then produced.

Thus, with the carbon dioxide emission amount report generation method of the present embodiment, a carbon dioxide emission amount report including details of the amount of carbon dioxide emitted by a printing apparatus as a merchandise in its lifetime can be produced, and then based on the carbon dioxide emission amount report thus produced, the manufacturer can work toward reduction of the carbon dioxide emitted by the printing apparatus as a merchandise in its lifetime. As a result, when the merchandise is manufactured based on the report produced by the carbon dioxide emission amount report producing method of the present embodiment, a merchandise putting even less load on the global environment can be introduced to the market. Thus, recent demands for reduced environmental load can be met.

Although the embodiments and modifications are described above, the present disclosure is not limited to those embodiments and can be carried out in various modes without departing from the gist thereof. For example, the above-described embodiments can be combined appropriately.

The present disclosure includes a configuration which is substantially the same as a configuration described in the embodiment (for example, a configuration having the same function, method, or outcome or a configuration having the same purpose or effect). Also, the present disclosure includes a configuration in which an unessential part of a configuration described in the embodiment is replaced. The present disclosure also includes a configuration which offers the same advantageous effect or accomplishes the same purpose as a configuration described in the embodiment. The present disclosure also includes a configuration having a publicly-known technique added to a configuration described in the embodiment.

The following points are derived from the above-described embodiment.

An aspect of a printing apparatus management is a printing apparatus management system that calculates an amount of carbon dioxide emitted by a first printing apparatus in a lifetime of the first printing apparatus, including: a processor that calculates, based on first calculation information, the amount of carbon dioxide emitted by the first printing apparatus in the lifetime; and an output unit that outputs a calculation result obtained by the processor, in which the first calculation information includes a usage quantity of a first material forming the first printing apparatus, a first emission coefficient indicating a unit amount of carbon dioxide emissions associated with production of the first material, a second emission coefficient indicating a unit amount of carbon dioxide emissions associated with disposal of the first material, a weight of the first printing apparatus, a third emission coefficient indicating a unit amount of carbon dioxide emissions associated with production of the first printing apparatus, a first transportation distance of transportation of the first printing apparatus using first transportation unit, a fourth emission coefficient indicating a unit amount of carbon dioxide emissions associated with transportation using the first transportation unit, a type of an expendable used for the first printing apparatus, a quantity of the expendable used for the first printing apparatus, a usage quantity of a second material forming the expendable, a fifth emission coefficient indicating a unit amount of carbon dioxide emissions associated with production of the second material, a sixth emission coefficient indicating a unit amount of carbon dioxide emissions associated with disposal of the second material, a weight of the expendable, a seventh emission coefficient indicating a unit amount of carbon dioxide emissions associated with production of the expendable, a second transportation distance of transportation of the expendable using second transportation unit, an eighth emission coefficient indicating a unit amount of carbon dioxide emissions associated with transportation using the second transportation unit, an amount of electric power consumed by the first printing apparatus, and a ninth emission coefficient indicating a unit amount of carbon dioxide emissions per amount of electric power.

According to this printing apparatus management system in which a processor calculates the amount of carbon dioxide emitted by a printing apparatus based on a usage quantity of a first material forming the first printing apparatus, a first emission coefficient indicating a unit amount of carbon dioxide emissions associated with production of the first material, a second emission coefficient indicating a unit amount of carbon dioxide emissions associated with disposal of the first material, a weight of the first printing apparatus, a third emission coefficient indicating a unit amount of carbon dioxide emissions associated with production of the first printing apparatus, a first transportation distance of transportation of the first printing apparatus using first transportation unit, a fourth emission coefficient indicating a unit amount of carbon dioxide emissions associated with transportation using the first transportation unit, a type of an expendable used for the first printing apparatus, a quantity of the expendable used for the first printing apparatus, a usage quantity of a second material forming the expendable, a fifth emission coefficient indicating a unit amount of carbon dioxide emissions associated with production of the second material, a sixth emission coefficient indicating a unit amount of carbon dioxide emissions associated with disposal of the second material, a weight of the expendable, a seventh emission coefficient indicating a unit amount of carbon dioxide emissions associated with production of the expendable, a second transportation distance of transportation of the expendable using second transportation unit, an eighth emission coefficient indicating a unit amount of carbon dioxide emissions associated with transportation using the second transportation unit, an amount of electric power consumed by the first printing apparatus, and a ninth emission coefficient indicating a unit amount of carbon dioxide emissions per amount of electric power, the amount of carbon dioxide emitted from not only the usage status of the printing apparatus, but also the production to the disposal of the printing apparatus can be calculated. Thus, the amount of carbon dioxide emitted by the printing apparatus in its lifetime can be calculated in detail, and also, appropriate measures can be taken for the printing apparatus to reduce carbon dioxide emitted by the printing apparatus in its lifetime so that a printing apparatus putting even less load on the global environment can be introduced to the market. Thus, recent demands for reduced environmental load can be met.

In the aspect of the printing apparatus management system, the first calculation information may include related-model information indicating a second printing apparatus related to the first printing apparatus, and when there is insufficiency in the first calculation information, the processor may compensate for the insufficiency by using second calculation information used to calculate an amount of carbon dioxide emitted by the second printing apparatus in a lifetime of the second printing apparatus and calculates the amount of carbon dioxide emitted by the first printing apparatus in the lifetime.

According to this printing apparatus management system, even when the first calculation information obtained by the processor has insufficiency, the amount of carbon dioxide emitted by the printing apparatus can be calculated, which improves convenience for the user of the printing apparatus management system.

In the aspect of the printing apparatus management system, the printing apparatus management system may include a notification unit that notifies when there is insufficiency in the first calculation information.

In the aspect of the printing apparatus management system, the first calculation information may include transfer quantity information on the first printing apparatus, and the processor may calculate, based on the transfer quantity information and the amount of carbon dioxide emitted by the first printing apparatus in the lifetime, an amount of carbon dioxide emitted by a first printing apparatus group including the first printing apparatus in a lifetime of the first printing apparatus group.

According to this printing apparatus management system, not only can the amount of carbon dioxide emitted by a printing apparatus be calculated for the printing apparatus alone, but the amount of carbon dioxide emitted by a printing apparatus group to which the printing apparatus belongs can also be calculated. Thus, the amount of carbon dioxide emitted by the printing apparatus and the printing apparatus group in its lifetime can be calculated in detail, and also, appropriate measures can be taken for the printing apparatus to reduce carbon dioxide emitted by the printing apparatus and the printing apparatus group in its lifetime so that a printing apparatus putting even less load on the global environment can be introduced to the market. Thus, recent demands for reduced environmental load can be met.

In the aspect of the printing apparatus management system, the processor may calculate, as the amount of carbon dioxide emitted by the first printing apparatus in the lifetime, a first emission amount including an amount of carbon dioxide emitted by the expendable in a lifetime of the expendable and a second emission amount not including the amount of carbon dioxide emitted by the expendable in the lifetime of the expendable.

According to the printing apparatus management system, a plurality of calculation results according to the status of the printing apparatus can be obtained. Thus, the amount of carbon dioxide emitted by the printing apparatus in its lifetime can be calculated in detail, and also, appropriate measures can be taken for the printing apparatus to reduce carbon dioxide emitted by the printing apparatus in its lifetime so that a printing apparatus putting even less load on the global environment can be introduced into the market. Thus, recent demands for reduced environmental load can be met.

In the aspect of the printing apparatus management system, the printing apparatus management system may include a first database, a second database, a third database, a fourth database, and a fifth database in which the first calculation information is stored, in which the first database may store, of the first calculation information, the usage quantity of the first material, the weight of the first printing apparatus, the type of the expendable used for the first printing apparatus, the quantity of the expendable used for the first printing apparatus, the usage quantity of the second material forming the expendable, the weight of the expendable, and the amount of electric power consumed by the first printing apparatus, the second database may store, of the first calculation information, the first emission coefficient, the second emission coefficient, the fifth emission coefficient, and the sixth emission coefficient, the third database may store, of the first calculation information, the third emission coefficient, the seventh emission coefficient, the first transportation distance, and the second transportation distance, the fourth database may store, of the first calculation information, the fourth emission coefficient and the eighth emission coefficient, and the fifth database may store, of the first calculation information, the ninth emission coefficient.

An aspect of a method for producing a carbon dioxide emission amount report is a method for producing a carbon dioxide emission amount report for reporting a lifetime emission amount of carbon dioxide emitted by a merchandise, the method including: a step of obtaining first calculation information used to calculate the lifetime emission amount of carbon dioxide; a step of calculating the lifetime emission amount based on the first calculation information obtained; and a step of producing a carbon dioxide emission amount report stating the lifetime emission amount calculated, in which the first calculation information includes a usage quantity of a first material forming the merchandise, a first emission coefficient indicating a unit amount of carbon dioxide emissions associated with production of the first material, a second emission coefficient indicating a unit amount of carbon dioxide emissions associated with disposal of the first material, a weight of the merchandise, a third emission coefficient indicating a unit amount of carbon dioxide emissions associated with production of the merchandise, a first transportation distance of transportation of the merchandise using first transportation unit, a fourth emission coefficient indicating a unit amount of carbon dioxide emissions associated with transportation using the first transportation unit, a type of an expendable used for the merchandise, a quantity of the expendable used for the merchandise, a usage quantity of a second material forming the expendable, a fifth emission coefficient indicating a unit amount of carbon dioxide emissions associated with production of the second material, a sixth emission coefficient indicating a unit amount of carbon dioxide emissions associated with disposal of the second material, a weight of the expendable, a seventh emission coefficient indicating a unit amount of carbon dioxide emissions associated with production of the expendable, a second transportation distance of transportation of the expendable using second transportation unit, an eighth emission coefficient indicating a unit amount of carbon dioxide emissions associated with transportation using the second transportation unit, an amount of electric power consumed by the merchandise, and a ninth emission coefficient indicating a unit amount of carbon dioxide emissions per amount of electric power.

According to this carbon dioxide emission amount report producing method in which a carbon dioxide emission amount report is produced based on information obtained which is a usage quantity of a first material forming the merchandise, a first emission coefficient indicating a unit amount of carbon dioxide emissions associated with production of the first material, a second emission coefficient indicating a unit amount of carbon dioxide emissions associated with disposal of the first material, a weight of the merchandise, a third emission coefficient indicating a unit amount of carbon dioxide emissions associated with production of the merchandise, a first transportation distance of transportation of the merchandise using first transportation unit, a fourth emission coefficient indicating a unit amount of carbon dioxide emissions associated with transportation using the first transportation unit, a type of an expendable used for the merchandise, a quantity of the expendable used for the merchandise, a usage quantity of a second material forming the expendable, a fifth emission coefficient indicating a unit amount of carbon dioxide emissions associated with production of the second material, a sixth emission coefficient indicating a unit amount of carbon dioxide emissions associated with disposal of the second material, a weight of the expendable, a seventh emission coefficient indicating a unit amount of carbon dioxide emissions associated with production of the expendable, a second transportation distance of transportation of the expendable using second transportation unit, an eighth emission coefficient indicating a unit amount of carbon dioxide emissions associated with transportation using the second transportation unit, an amount of electric power consumed by the merchandise, and a ninth emission coefficient indicating a unit amount of carbon dioxide emissions per amount of electric power, a carbon dioxide emission amount report including not only the usage status of the merchandise but also the production and disposable thereof can be produced. Then, when the merchandise is manufactured based on the carbon dioxide emission amount report produced, the amount of carbon dioxide emitted by the printing apparatus in its lifetime can be calculated in detail, and also, appropriate measures can be taken for the printing apparatus to reduce carbon dioxide emitted by the printing apparatus in its lifetime so that a printing apparatus putting even less load on the global environment can be introduced to the market. Thus, recent demands for reduced environmental load can be met.

What is claimed is:

1. A printing apparatus management system that calculates an amount of carbon dioxide emitted by a first printing apparatus in a lifetime of the first printing apparatus, comprising:
a processor that calculates, based on first calculation information, the amount of carbon dioxide emitted by the first printing apparatus in the lifetime; and
an output unit that outputs a calculation result obtained by the processor, wherein
the first calculation information includes
a usage quantity of a first material forming the first printing apparatus,
a first emission coefficient indicating a unit amount of carbon dioxide emissions associated with production of the first material,
a second emission coefficient indicating a unit amount of carbon dioxide emissions associated with disposal of the first material,
a weight of the first printing apparatus,
a third emission coefficient indicating a unit amount of carbon dioxide emissions associated with production of the first printing apparatus,
a first transportation distance of transportation of the first printing apparatus using first transportation unit,
a fourth emission coefficient indicating a unit amount of carbon dioxide emissions associated with transportation using the first transportation unit,
a type of an expendable used for the first printing apparatus,
a quantity of the expendable used for the first printing apparatus,
a usage quantity of a second material forming the expendable,
a fifth emission coefficient indicating a unit amount of carbon dioxide emissions associated with production of the second material,
a sixth emission coefficient indicating a unit amount of carbon dioxide emissions associated with disposal of the second material,
a weight of the expendable,
a seventh emission coefficient indicating a unit amount of carbon dioxide emissions associated with production of the expendable,
a second transportation distance of transportation of the expendable using second transportation unit,
an eighth emission coefficient indicating a unit amount of carbon dioxide emissions associated with transportation using the second transportation unit,
an amount of electric power consumed by the first printing apparatus, and
a ninth emission coefficient indicating a unit amount of carbon dioxide emissions per amount of electric power.

2. The printing apparatus management system according to claim 1, wherein
the first calculation information includes related-model information indicating a second printing apparatus related to the first printing apparatus, and
when there is insufficiency in the first calculation information, the processor compensates for the insufficiency by using second calculation information used to calculate an amount of carbon dioxide emitted by the second printing apparatus in a lifetime of the second printing apparatus and calculates the amount of carbon dioxide emitted by the first printing apparatus in the lifetime.

3. The printing apparatus management system according to claim 1, comprising a notification unit that notifies when there is insufficiency in the first calculation information.

4. The printing apparatus management system according to claim 1, wherein
the first calculation information includes transfer quantity information on the first printing apparatus, and
the processor calculates, based on the transfer quantity information and the amount of carbon dioxide emitted by the first printing apparatus in the lifetime, an amount of carbon dioxide emitted by a first printing apparatus group including the first printing apparatus in a lifetime of the first printing apparatus group.

5. The printing apparatus management system according to claim 1, wherein
the processor calculates, as the amount of carbon dioxide emitted by the first printing apparatus in the lifetime, a first emission amount including an amount of carbon dioxide emitted by the expendable in a lifetime of the expendable and a second emission amount not including the amount of carbon dioxide emitted by the expendable in the lifetime of the expendable.

6. The printing apparatus management system comprising a first database, a second database, a third database, a fourth database, and a fifth database in which the first calculation information is stored, wherein
the first database stores, of the first calculation information, the usage quantity of the first material, the weight of the first printing apparatus, the type of the expendable used for the first printing apparatus, the quantity of the expendable used for the first printing apparatus, the usage quantity of the second material forming the expendable, the weight of the expendable, and the amount of electric power consumed by the first printing apparatus,
the second database stores, of the first calculation information, the first emission coefficient, the second emission coefficient, the fifth emission coefficient, and the sixth emission coefficient,
the third database stores, of the first calculation information, the third emission coefficient, the seventh emission coefficient, the first transportation distance, and the second transportation distance,
the fourth database stores, of the first calculation information, the fourth emission coefficient and the eighth emission coefficient, and
the fifth database stores, of the first calculation information, the ninth emission coefficient.

7. A method for producing a carbon dioxide emission amount report for reporting a lifetime emission amount of carbon dioxide emitted by a merchandise, the method comprising:
a step of obtaining first calculation information used to calculate the lifetime emission amount of carbon dioxide;
a step of calculating the lifetime emission amount based on the first calculation information obtained; and
a step of producing a carbon dioxide emission amount report stating the lifetime emission amount calculated, wherein
the first calculation information includes
a usage quantity of a first material forming the merchandise,
a first emission coefficient indicating a unit amount of carbon dioxide emissions associated with production of the first material,
a second emission coefficient indicating a unit amount of carbon dioxide emissions associated with disposal of the first material,
a weight of the merchandise,
a third emission coefficient indicating a unit amount of carbon dioxide emissions associated with production of the merchandise,
a first transportation distance of transportation of the merchandise using first transportation unit,
a fourth emission coefficient indicating a unit amount of carbon dioxide emissions associated with transportation using the first transportation unit,
a type of an expendable used for the merchandise,
a quantity of the expendable used for the merchandise,
a usage quantity of a second material forming the expendable,
a fifth emission coefficient indicating a unit amount of carbon dioxide emissions associated with production of the second material,
a sixth emission coefficient indicating a unit amount of carbon dioxide emissions associated with disposal of the second material,
a weight of the expendable,
a seventh emission coefficient indicating a unit amount of carbon dioxide emissions associated with production of the expendable,
a second transportation distance of transportation of the expendable using second transportation unit,
an eighth emission coefficient indicating a unit amount of carbon dioxide emissions associated with transportation using the second transportation unit,
an amount of electric power consumed by the merchandise, and
a ninth emission coefficient indicating a unit amount of carbon dioxide emissions per amount of electric power.
